(19) United States
(12) Patent Application Publication
(10) Pub. No.: US 2022/0321016 A1
(43) Pub. Date: Oct. 6, 2022

(54) MULTI-PORT POWER CONVERTERS AND POWER CONVERSION SYSTEMS, AND METHODS FOR DESIGN AND OPERATION THEREOF

(71) Applicant: UNIVERSITY OF MARYLAND, COLLEGE PARK, College Park, MD (US)

(72) Inventors: Alireza KHALIGH, Arlington, VA (US); Akshay SINGH, Mountain View, CA (US); Apurv Kumar YADAV, College Park, MD (US); Chanaka SINGHABAHU, College Park, MD (US); Jianfei CHEN, Lanham, MD (US)

(21) Appl. No.: 17/707,163

(22) Filed: Mar. 29, 2022

Related U.S. Application Data
(60) Provisional application No. 63/167,616, filed on Mar. 29, 2021.

(51) Int. Cl. H02M 3/335; H02M 1/44; H02M 1/42; H02M 3/00

(52) U.S. Cl. CPC H02M 3/33573; H02M 1/44; H02M 3/33576; H02M 1/4241; H02M 3/01

(57) ABSTRACT

A multi-port power conversion system can have a multi-winding transformer and at least three ports. Each port can be coupled to the multi-winding transformer. Each port can have a semiconductor bridge and a coupling network. For each port, the semiconductor bridge can have two or more levels and can comprise at least two switches. The coupling network for each port can comprise at least one inductor. The semiconductor bridge can be coupled to the multi-winding transformer via the respective coupling network. The multi-port power conversion system can have a multi-active bridge (MAB) architecture that is universally applicable to AC-DC, DC-DC, DC-AC, and AC-AC conversion applications and extendable to any number of ports.

### CROSS-REFERENCE TO RELATED APPLICATIONS

The present application claims the benefit of U.S. Provisional Application No. 63/167,616, filed Mar. 29, 2021, entitled “Multi-port Power Converter System,” which is incorporated by reference herein in its entirety.

### FIELD

The present disclosure relates generally to power conversion, and more particularly, to power converters having at least two output ports, for example, multi-active-bridge (MAB) power converters.

### BACKGROUND

With increased electrical integration and demand for multiple voltage- and power levels, multi-port power electronic converters provide an effective method of realizing compact and efficient power conversion. Historically, power conversion from one voltage level to multiple voltage levels was performed using discrete AC-DC and/or DC-DC converters that meet the isolation requirements associated with each voltage level. Due to a very low level of integration and cascading of power electronic stages, such solutions suffer from large volume/weight and low efficiencies. Nevertheless, such multiple input/output power electronic architectures are extensively used in a wide range of applications. For example, in electric vehicles (EVs), there is a need for power conversion between the AC wall input, the high-voltage (HV) battery, and one or more low-voltage (LV) batteries and/or supercapacitors. Many of these interfaces must be designed as bidirectional, to meet the functionality demands associated with the next generation of EVs. While multi-port converters with isolation have been developed, such converter architectures typically only provide DC-DC conversion. Furthermore, there are varying degrees of integration in existing designs, such as cascaded power electronic stages, multi-winding transformers, etc. For example, in designs where multi-winding transformers are used for the electrical- and magnetic integration, the coupling inductance is limited to an inductor, which greatly limits the operation range and possibility for zero-voltage switching (ZVS) and zero-current switching (ZCS) over wide voltage and load ranges.

Embodiments of the disclosed subject matter may address one or more of the above-noted problems and disadvantages, among other things.

### SUMMARY

Embodiments of the disclosed subject matter provide power conversion systems employing multi-directional multi-port power converters. In some embodiments, power conversion is provided by a multi-active bridge (MAB) power converter having at least three ports, among which at least one port is an input and at least one port is an output. Some embodiments employ an electrically- and magnetically-integrated multidirectional isolated multi-port conversion architecture that is universally applicable to AC-DC, DC-DC, DC-AC, and AC-AC conversion applications. In some embodiments, a unified power management strategy for multi-port converter systems is provided, based on optimal closed-loop multi-phase-shift, multi-duty ratio, variable switching frequency operation.

In one or more embodiments, a multi-port power conversion can comprise a multi-winding transformer and at least three ports. The at least three ports can be coupled to the multi-winding transformer. Each port can have a semiconductor bridge and a coupling network. The semiconductor bridge of each port can have two or more levels and can comprise at least two switches. The coupling network for each port can comprise at least one inductor. The semiconductor bridge can be coupled to the multi-winding transformer via the respective coupling network.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified schematic diagram illustrating a circuit configuration for an MAB power converter, according to one or more embodiments of the disclosed subject matter.

FIGS. 2A-2F are simplified schematic diagrams illustrating circuit configurations for semiconductor bridge types 1-6, respectively, according to one or more embodiments of the disclosed subject matter.

FIGS. 3A-3D are simplified schematic diagrams illustrating circuit configurations for MAB power converters with transformer types i-iv, respectively, according to one or more embodiments of the disclosed subject matter.

FIGS. 4A-4G are simplified schematic diagrams illustrating circuit configurations for resonant coupling networks (RCNs) types a-g, respectively, according to one or more embodiments of the disclosed subject matter.

FIGS. 5A-5B are simplified schematic diagrams illustrating circuit configurations for MAB resonant power converters with matrix transformer for four ports and three ports, respectively, according to one or more embodiments of the disclosed subject matter.

FIGS. 6A-6B are simplified schematic diagrams illustrating circuit configurations for MAB resonant power converters with four ports and three ports, respectively, according to one or more embodiments of the disclosed subject matter.

FIGS. 7A-7B are simplified schematic diagrams illustrating circuit configurations for MAB non-resonant power converters (e.g., purely inductive) with matrix transformer for four ports and three ports, respectively, according to one or more embodiments of the disclosed subject matter.

FIGS. 8A-8B are simplified schematic diagrams illustrating circuit configurations for MAB power converters with three-phase AC input and employing a back-to-back transistor structure (e.g., direct single-stage AC port) for four ports and three ports, respectively, according to one or more embodiments of the disclosed subject matter.

FIG. 9 is a simplified schematic diagram illustrating configuration of a modular parallel architecture of single-phase MAB power converters for a three-phase AC port, according to one or more embodiments of the disclosed subject matter.

FIG. 10 is a simplified schematic diagram illustrating a circuit configuration for an MAB power converter employing back-to-back transistor structure (e.g., direct single-stage AC port) for an AC port, according to one or more embodiments of the disclosed subject matter.

FIG. 11 is a simplified schematic diagram illustrating a circuit configuration for an MAB power converter with a two-stage converter (e.g., separate power factor correction (PFC)) for an AC port, according to one or more embodiments of the disclosed subject matter.

FIG. 12 is a simplified schematic diagram illustrating a circuit configuration for an MAB power converter with three-phase AC input and employing a synchronous rectifier structure (e.g., indirect single-stage AC port) for an AC port, according to one or more embodiments of the disclosed subject matter.

FIG. 13 is a simplified schematic diagram illustrating a circuit configuration for an MAB power converter with a three-phase AC input and employing a two-stage converter (e.g., separate PFC) for an AC port, according to one or more embodiments of the disclosed subject matter.

FIG. 14 is a simplified schematic diagram illustrating a circuit configuration for an MAB resonant power converter with four ports employing asymmetric resonant networks, according to one or more embodiments of the disclosed subject matter.

FIG. 15A is a simplified schematic diagram of a first modular architecture of MAB power converters for a three-phase AC input and single-phase output modules, according to one or more embodiments of the disclosed subject matter.

FIG. 15B is a simplified schematic diagram of a second modular architecture of MAB power converters for a three-phase AC input and asymmetric, single-phase output modules, according to one or more embodiments of the disclosed subject matter.

FIG. 16A is a simplified schematic diagram of a third modular architecture of MAB power converters for a three-phase AC input and asymmetric, single-phase output modules, according to one or more embodiments of the disclosed subject matter.

FIG. 16B is a simplified schematic diagram of a fourth modular architecture of MAB power converters for a three-phase AC input and asymmetric, single-phase output modules, according to one or more embodiments of the disclosed subject matter.

FIG. 17A is a simplified schematic diagram of a fifth modular architecture of MAB power converters for a three-phase AC input, asymmetric, single-phase output modules, and series/parallel arrangements at the DC ports, according to one or more embodiments of the disclosed subject matter.

FIG. 17B is a simplified schematic diagram of a sixth modular architecture of MAB power converters for a three-phase AC input, asymmetric, single-phase output modules, and series/parallel arrangements at the DC ports, according to one or more embodiments of the disclosed subject matter.

FIG. 18A is a simplified schematic diagram of a seventh modular architecture of MAB power converters for a three-phase AC input and three-phase output modules, according to one or more embodiments of the disclosed subject matter.

FIG. 18B is a simplified schematic diagram of an eighth modular architecture of MAB power converters for a three-phase AC input and asymmetric, three-phase output modules, according to one or more embodiments of the disclosed subject matter.

FIG. 19 is a simplified schematic diagram of a ninth modular architecture of MAB power converters for a three-phase AC input and asymmetric, single-phase and three-phase output modules, according to one or more embodiments of the disclosed subject matter.

FIG. 20A is a simplified schematic diagram of a tenth modular architecture of MAB power converters for a single-phase AC input and single-phase output modules, according to one or more embodiments of the disclosed subject matter.

FIG. 20B is a simplified schematic diagram of an eleventh modular architecture of MAB power converters for a single-phase AC input and asymmetric, single-phase output modules, according to one or more embodiments of the disclosed subject matter.

FIG. 21 is a simplified schematic diagram of a twelfth modular architecture of MAB power converters for a single-phase AC input and single-phase output modules with a power pulsation buffer (PPB), according to one or more embodiments of the disclosed subject matter.

FIG. 22A is a simplified schematic diagram of a thirteenth modular architecture of MAB power converters for a single-phase AC input and single-phase output modules, with series connection on the AC port, according to one or more embodiments of the disclosed subject matter.

FIG. 22B is a simplified schematic diagram of a fourteenth modular architecture of MAB power converters for a single-phase AC input and asymmetric, single-phase output modules, with series/parallel connections at both AC and DC ports, according to one or more embodiments of the disclosed subject matter.

FIG. 23A is a simplified schematic diagram of a fifteenth modular architecture of MAB power converters for a three-phase AC input and single-phase output modules, with an additional DC-DC converter, according to one or more embodiments of the disclosed subject matter.

FIG. 23B is a simplified schematic diagram of a sixteenth modular architecture of MAB power converters for a three-phase AC input and three-phase output modules, with an additional DC-DC converter, according to one or more embodiments of the disclosed subject matter.

FIG. 24 is a simplified schematic diagram illustrating a circuit configuration for an MAB power converter with four ports, according to one or more embodiments of the disclosed subject matter.

FIG. 25 illustrates phase-shift modulation (PSM) and pulse-frequency modulation (PFM) variables on the DC ports of the MAB converter of FIG. 24, according to one or more embodiments of the disclosed subject matter.

FIG. 26 is a simplified schematic diagram illustrating a circuit configuration for an MAB power converter with half-bridges on two of the four ports, according to one or more embodiments of the disclosed subject matter.

FIG. 27 illustrates hybrid PSM and pulse-width modulation (PWM) variables, along with switching frequency, for the MAB power converter of FIG. 26, according to one or more embodiments of the disclosed subject matter.

FIG. 28 is a simplified schematic diagram illustrating a circuit configuration for an MAB power converter with a multilevel bridge on one of the ports, according to one or more embodiments of the disclosed subject matter.

FIG. 29 illustrates phase shift and frequency modulation variables for the multilevel bridge of the MAB power converter of FIG. 28, according to one or more embodiments of the disclosed subject matter.

FIG. 30 is a simplified schematic diagram illustrating a circuit configuration for an MAB power converter with a single-stage single-phase AC port, according to one or more embodiments of the disclosed subject matter.

FIG. 31 illustrates discretized treatment of phase shift and frequency modulation variables in the MAB power converter of FIG. 30, according to one or more embodiments of the disclosed subject matter.

FIG. 32 is a simplified schematic diagram illustrating a circuit configuration for an MAB power converter with a power pulsation buffer port, according to one or more embodiments of the disclosed subject matter.

FIG. 33 is a simplified schematic diagram illustrating aspects of an equivalent n-port network analysis method for an MAB power converter, according to one or more embodiments of the disclosed subject matter.

FIG. 34 is a process flow diagram of a method for optimization of parameters for modulation, multiport transformer, and RCNs, according to one or more embodiments of the disclosed subject matter.

FIGS. 35A-35B are simplified schematic diagrams illustrating aspects of closed-loop output voltage control and closed-loop output current control, respectively, of an MAB power converter, according to one or more embodiments of the disclosed subject matter.

FIG. 36 is a simplified schematic diagram illustrating aspects of decoupled and feed-forward closed-loop control of an MAB resonant power converter, according to one or more embodiments of the disclosed subject matter.

FIG. 37 depicts a generalized example of a computing environment in which the disclosed technologies may be implemented.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### INTRODUCTION

Prior power systems employ discrete AC-to-DC (or AC-DC) and DC-to-DC (or DC-DC) converters. Such prior architectures use at least two conversion stages and at least two discrete converters. In contrast, embodiments of the disclosed subject matter allow for interfacing of all ports using a single integrated multi-port converter, in particular, by integrating all power electronics into a single-stage multi-port energy router with multi-directional (multiple-input multiple-output, or MIMO) power transfer capability. In some embodiments, substantial improvements in power density and efficiency can be achieved using a circuit architecture that offers electrical and magnetic integration, and direct DC-link-capacitor-less AC-DC conversion and DC-DC conversion circuit topologies. In some embodiments, the use of resonant coupling networks (RCNs) with a multi-active bridge (MAB) converter enhances efficiency and electromagnetic interference (EMI) performance over conventional converters. As further used herein below, the terms “multi-port converter,” “multi-port architecture,” and “multi-active bridge (MAB) converter” have been used interchangeably to refer to an isolated power electronics converter with two or more ports according to one or more embodiments of the disclosed subject matter.

In some embodiments, the multi-port converter can be adapted for multiple voltage levels associated with electric vehicle (EV) charging systems. For example, typical voltage levels in EV charging systems can include 800V, 400 V, 48 V, 24 V, 12 V, etc. Alternatively or additionally, in some embodiments, the multi-port converter can be adapted for energy routing in next-generation smart DC homes. For example, in such smart home DC distribution systems, power converters interface the AC grid to various DC voltage buses having voltage levels such as, but not limited to, 1200V, 800V, 400 V, 48 V, 24 V, and 12 V. Alternatively or additionally, in some embodiments, the multi-port converter can be adapted for power distribution in a data center, for example, to interface AC input to battery storage and/or to various DC voltage buses for server applications. For example, the DC voltages buses can have voltage levels such as, but not limited to, 400 V, 230 V, 48 V, 12 V, and 1 V. Alternatively or additionally, in some embodiments, the multi-port converter can be adapted for power distribution in person computing, for example, to generate various voltage levels for different computing loads such as, but not limited to, 12 V, 5 V, 3.3 V, 1.8 V, and 1.1 V. Other applications beyond those specifically discussed above are also possible according to one or more contemplated embodiments. Indeed, based on the teachings of the present disclosure, a multi-port converter can be developed for use in any application having multiple voltage ports and/or power flow directions, such as, but not limited to, renewable energy generation and storage, and electric aircrafts.

In some embodiments, a power management control strategy for the MAB converter can be employed, for example, to provide for optimal RMS currents and zero-voltage switching (ZVS) of all MOSFET devices over an entire load range. In some embodiments, the proposed control can achieve independent decoupled control of the voltages and currents at each port. In some embodiments, the MAB converter can be modeled using an analytical modeling approach, for example, using a superposed-harmonics method in the frequency domain that is subsequently deployed in a numerical optimization algorithm. In some embodiments, the optimization algorithm obtains optimal modulation parameters for a given operating condition using numerical optimization, and also finds the optimal converter parameters (e.g., converter inductances, capacitances, and transformer turns ratios). In some embodiments, the multi-port converter employs an alternative circuit topology with a two-stage configuration, which may be able to achieve specific targets in certain applications.

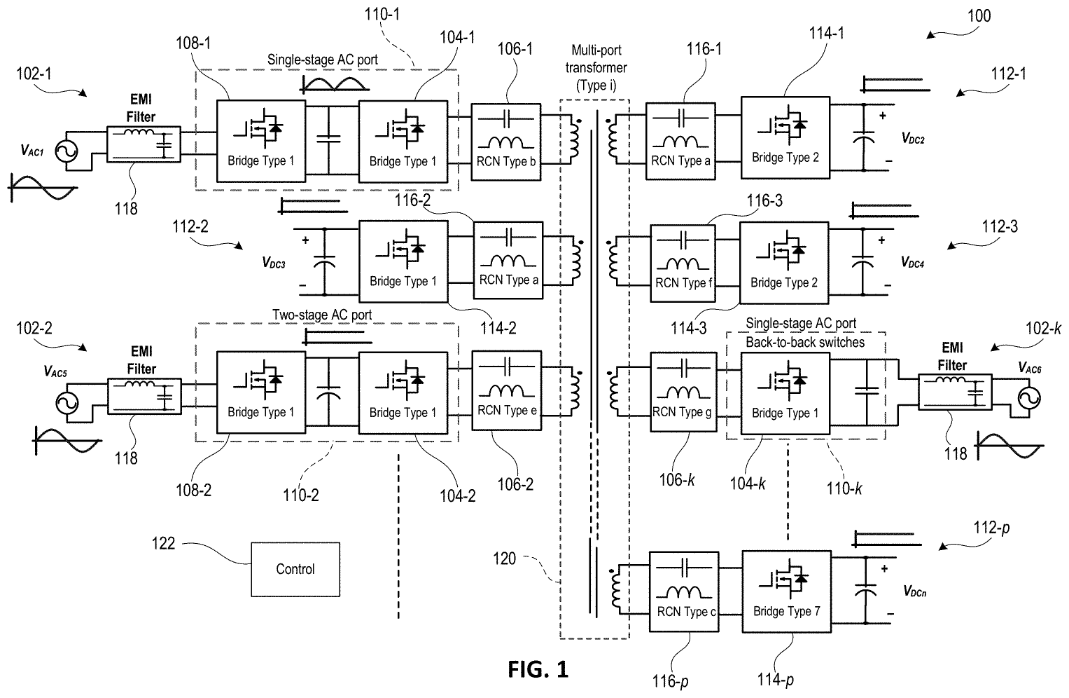

In some embodiments, the MAB converter employs at least three ports, for example, four or more ports. Although many of the examples presented herein illustrate three or four ports, it should be noted that embodiments of the disclosed subject matter are not limited thereto. Rather, the MAB converter can have any number of ports according to one or more contemplated embodiments, and one of skill in the art will readily understand that the teachings presented herein can be readily extended to two-port converters (e.g., dual-active bridge), three-port converters (e.g., triple-active bridge), and/or n-port converters (e.g., n-tuple active bridge). For example, FIG. 1 shows an exemplary configuration of a generic n-port converter 100, which has an arbitrary number of ports 102-1, 102-2, . . . 102-k interfaced to AC voltages (e.g., AC grid, electric drive load, etc.) and an arbitrary number of ports 112-1, 112-2, 112-3, . . . 112-p (e.g., where n=k+p) interfaced to various DC voltages levels (e.g., for different electrical and/or electronic loads). In some embodiments, the number of AC ports 102-1 through 102-k can be different than the number of DC ports 112-1 through 112-p.

In the illustrated example of FIG. 1, each port 102, 112 of the MAB converter 100 has one or more semiconductor device bridge(s) 104, 114 and a respective resonant coupling network (RCN) 106, 116. The ports 102, 112 can be magnetically coupled through a multi-winding transformer 120. If the given port has an AC voltage interface (e.g., ports 102-1 through 102-k), then an additional synchronous rectifier/inverter 108 and an EMI filter 118 may also be included. Together, the inverter 108 and semiconductor device bridge 104 can form a single-stage configuration, such as configuration 110-1 of AC port 102-1. Alternatively or additionally, in some embodiments, back-to-back switches can be used in forming a single stage configuration, such as configuration 110-k of AC port 102-k. Alternatively, in some embodiments, a separate power factor correction (PFC) AC-DC rectifier may be interfaced on the AC port 102-2 to obtain a pure DC voltage for the corresponding port (e.g., input to bridge 104) of the MAB converter 100 (e.g., two-stage configuration 110-2).

In some embodiments, each port 102, 112 may have a semiconductor bridge configuration 104, 108, 114 (e.g., selected from the options in Table 1) that is the same or different from the other ports and/or a resonant coupling network (RCN) 106, 116 configuration (e.g., selected from the options in Table 3 Error! Reference source not found.) that is the same or different from the other ports. For example, selection of unique arrangements for each port may be used to optimize operation of the MAB converter 100. Alternatively, in some embodiments, the MAB converter 100 may have a transformer 120, the structure of which is selected, for example, from the configurations listed in Table 2.

### Exemplary Semiconductor Bridge Configurations

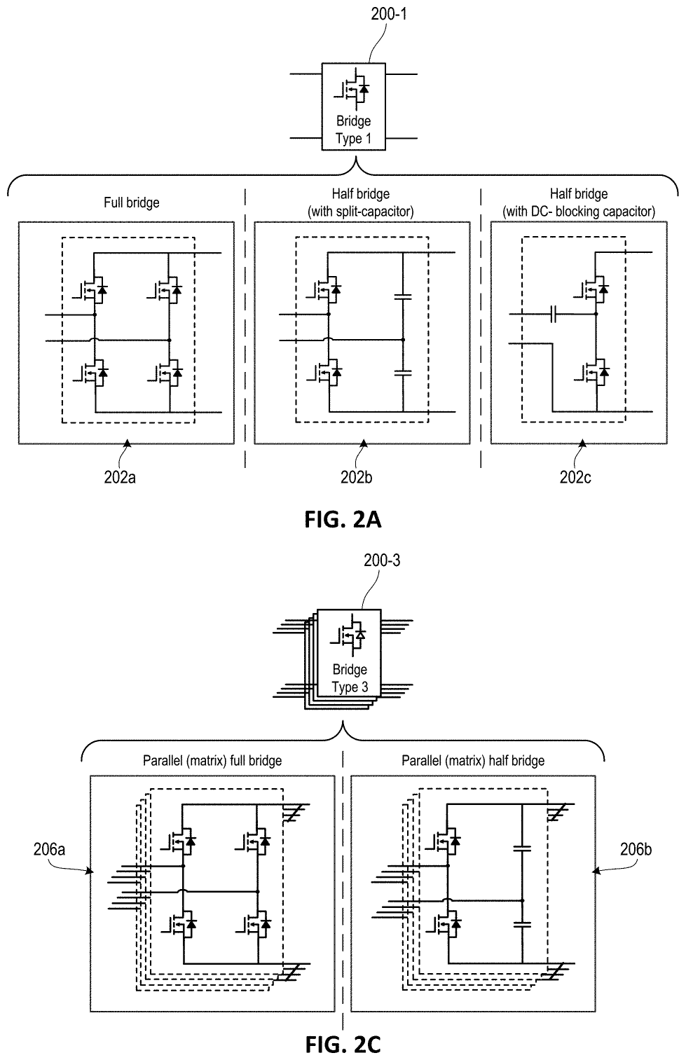

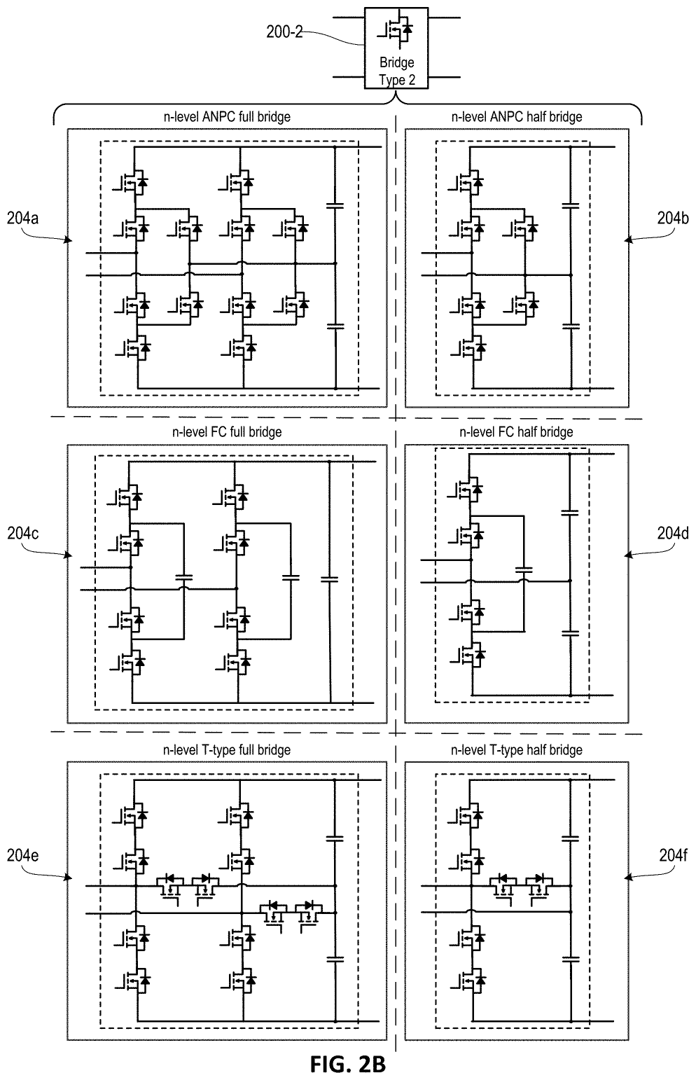

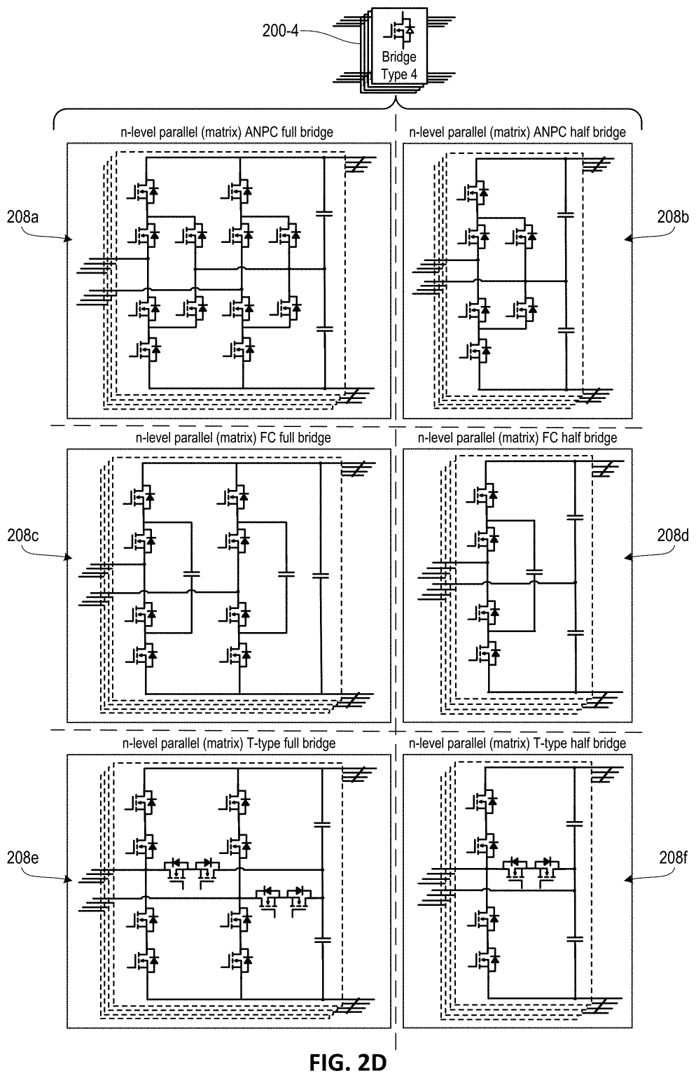

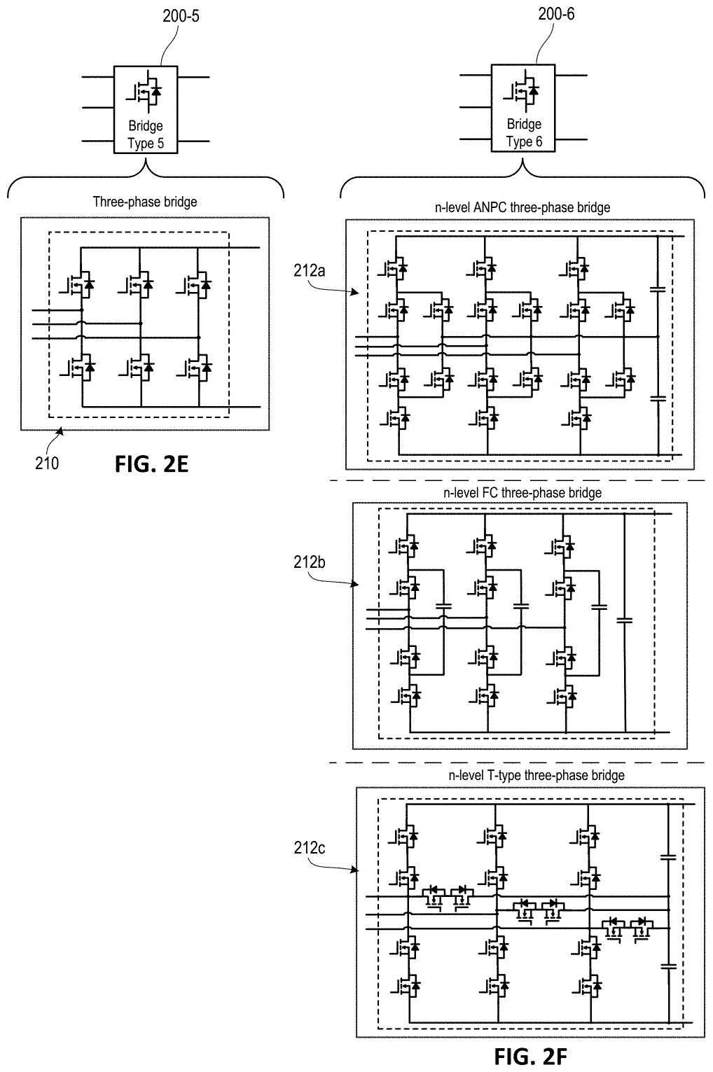

In some embodiments, one or more of the semiconductor bridge configurations for each port, such as semiconductor bridge 104, 108 of any of AC ports 102-1 through 102-k and semiconductor bridge 114 of any of DC ports 112-1 through 112-p, can be selected from any of the topological variations summarized in Table 1 below and illustrated in FIGS. 2A-2F.

TABLE 1
Exemplary bridge configurations for use in an MAB converter.

| Bridge | | |
|---|---|---|
| Configuration | FIG. | Description/Variations |
| Bridge Type 1 | FIG. 2A | Full-bridge (202a) |
| (200-1) | | Half-bridge (with split capacitors) (202b) |
| | | Half-bridge (with DC-blocking capacitor) (202c) |
| Bridge Type 2 | FIG. 2B | m-level ANPC or NPC full-bridge (204a) |
| (200-2) | | m-level ANPC or NPC half-bridge (204b) |
| | | m-level FC full-bridge (204c) |
| | | m-level FC half-bridge (204d) |
| | | m-level T-type full-bridge (204e) |
| | | m-level T-type half-bridge (204f) |
| Bridge Type 3 | FIG. 2C | Parallel/matrix variations of Type 1 |
| (200-3) | | (full-bridge 206a, half-bridge 206b) |
| Bridge Type 4 | FIG. 2D | Parallel/matrix variations of Type 2 |
| (200-4) | | (m-level ANPC full-bridge 208a, m-level ANPC half- |
| | | bridge 208b, m-level FC full-bridge 208c, m-level FC |
| | | half-bridge 208d, m-level T-type full-bridge 208e, m- |
| | | level T-type half-bridge 208f) |
| Bridge Type 5 | FIG. 2E | Three-phase bridge (210) |
| (200-5) | | |
| Bridge Type 6 | FIG. 2F | Three-phase m-level bridge |
| (200-6) | | (ANPC 212a, FC 212b, T-type 212c) |

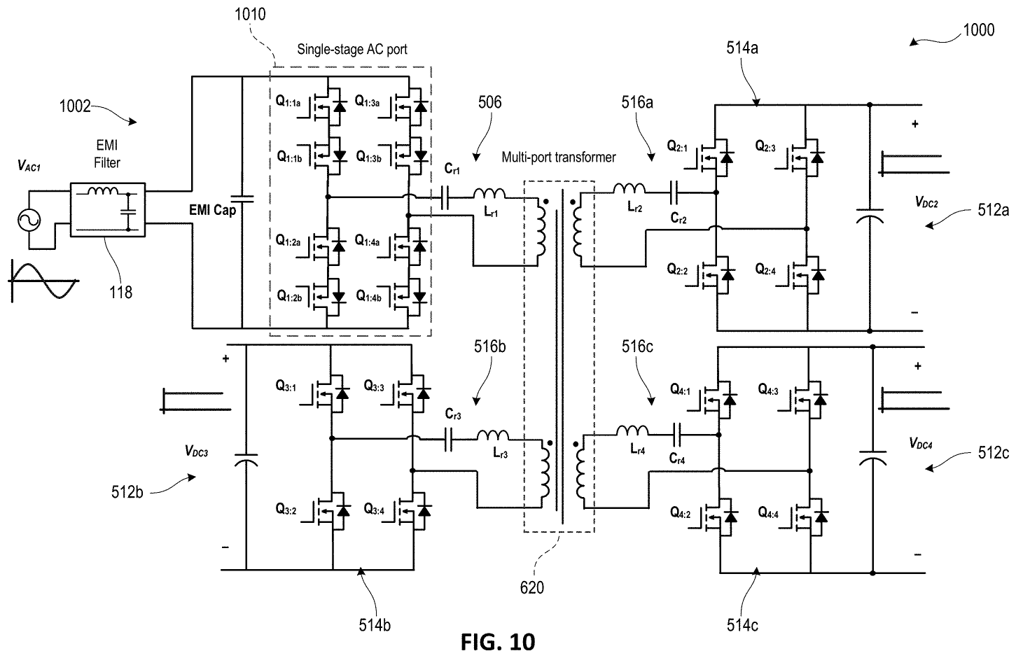

The bridge configurations can be broadly classified as 2-level and multi-level (m-level), based on the number of voltage levels generated from each half-bridge leg. Furthermore, single-phase or three-phase version of the semiconductor bridges can be deployed in the MAB converter. In some embodiments, the bridges can be configured in parallel when connected to a matrix transformer. In some embodiments, a current-source bridge with a DC inductor can couple the semiconductor bridge to the voltage source or load at a given port. In some embodiments, for each configuration of FIGS. 2A-2F, each transistor can be replaced with a series or parallel connection of multiple transistors, for example, to increase the effective voltage or current ratings, respectively. Alternatively or additionally, the discrete transistors in any of the bridge structures disclosed herein can be replaced with back-to-back switches, for example, if a bridge is used on an AC port with a direct single-stage AC port structure, such as illustrated in FIG. 10.

Referring to FIG. 2A, two-level bridge topologies 202a-202c that can be used for Bridge Type 1 (200-1) are shown. The 2-level bridge topologies 202a-202c can offer a simple and low-cost design with a low component count. The maximum number of degrees of freedom for modulating a 2-level full-bridge 202a is two, for example, using phase-shift modulation (PSM). For a 2-level half-bridge 202b or 202c, two degrees of freedom can also be achieved using a combination of PSM and phase-width modulation (PWM) techniques, along with a split capacitor (as in 202b) or with a DC-blocking capacitor (as in 202c).

Referring to FIG. 2B, multi-level bridge topologies 204a-204f that can be used for Bridge Type 2 (200-2) are shown. While FIG. 2B presents 3-level structures for each leg (or 5-level for a full bridge), each leg can be extended to an m-level structure within this framework. The lower voltage stresses with a multilevel bridge may result in more optimal semiconductor device selections and lower costs. Moreover, with a higher number of voltage levels, a more precise volt-second balance can be achieved across the RCNs, thus resulting in lower root mean square (RMS) currents and higher efficiencies, for example, in scenarios with wide voltage variations on a given port. In some embodiments, use of a multilevel bridge can introduce several additional phase shifts (e.g., degrees of freedom) compared to a standard 2-level structure, and the number of additional phase shifts can increase with the number of levels in the multilevel bridge. In some embodiments, the multilevel bridge may also be effective in reducing conduction losses in AC-DC MAB applications and for high voltage step-down applications.

In FIG. 2B, three possible circuit topologies are illustrated for a multilevel bridge configuration, in particular, (1) an active neutral point clamped (ANPC) structure, (2) a flying-capacitor (FC) structure, and (3) a T-type structure. While the exact switching logics differ for ANPC, FC, and T-type bridge configurations, the analytical treatment is similar, and one of skill in the art can readily extend the analysis for 2-level bridge configurations. Additionally, other multi-level switched capacitor topologies can be directly interfaceable with the high-frequency multi-port transformer in an MAB converter. For any of the ANPC, FC, or T-type bridge configurations, the multilevel bridges can be configured as either a full-bridge (e.g., 204a, 204c, 204e) or a half-bridge (e.g., 204b, 204d, 204f).

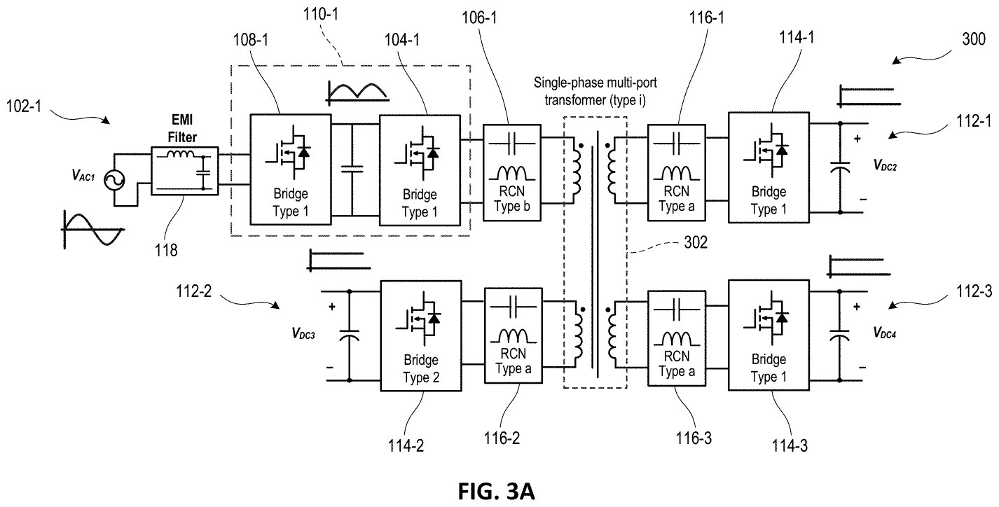

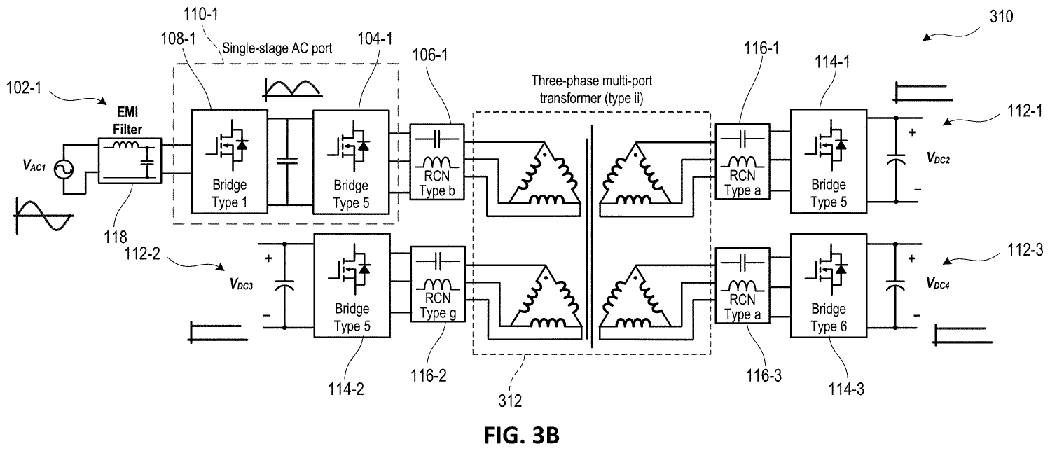

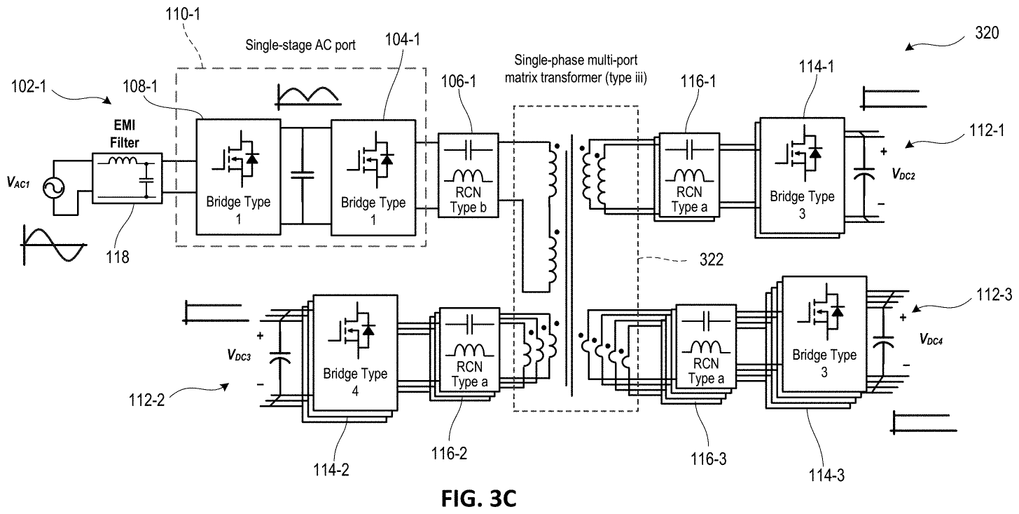

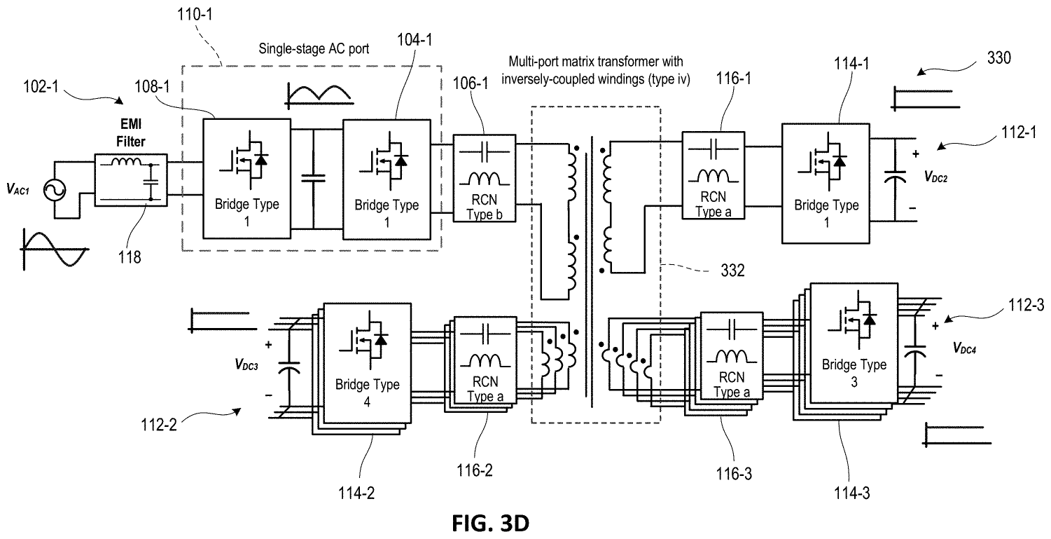

FIG. 2C shows multi-level bridge topologies 206a, 206b that can be used for Bridge Type 3 (200-3), and FIG. 2D shows multi-level bridge topologies 208a-208f that can be used for Bridge Type 4 (200-4). Bridge Types 3 and 4 represent the parallel-connected versions of Bridge Types 1 and 2, respectively, that can be used in matrix transformer arrangements (for example, as described with respect to FIG. 3C). In these configurations, the semiconductor bridges are connected in parallel and share a common DC voltage. However, the high-frequency AC terminals are connected to independent RCNs and corresponding independent windings in a matrix transformer configuration. This configuration allows for reduced conduction losses compared to a single bridge (e.g., Bridge Types 1 and 2) and thus can be deployed for high-current low-voltage ports in an MAB converter. In such a configuration, the corresponding transistors in paralleled bridges can switch in synchronization. Furthermore, in some embodiments, current balancing between paralleled bridges can be achieved using active and passive design methods, for example, active and passive techniques known in the art.

The bridge configurations described above can be applicable to single-phase transformers. However, in some embodiments, the bridge configurations can be used with three-phase transformer structures. For example, FIG. 2E shows a three-phase two-level bridge topology 210 that can be used for Bridge Type 5 (200-5), and FIG. 2F shows three-phase multi-level bridge topologies 212a-212c that can be used for Bridge Type 6 (200-6). In some embodiments, in addition to or in place of being used for the high-frequency semiconductor bridges, the three-phase bridge 210, 212a-212c can also be as a line-frequency synchronous rectifier, for example, to interface three-phase AC inputs to an MAB converter.

### Exemplary Transformer Configurations

In some embodiments, the flexibility in the operation of the MAB converter can allow for magnetic integration through several different transformer configurations. The transformer can form the main coupling element between various ports. In some embodiments, the transformer can also be the largest passive component in the MAB converter circuit. Proper selection of the transformer configuration can assist in achieving high efficiency and power density. In some embodiments, the transformer configuration coupling together the ports, such as transformer 120 in FIG. 1, can be selected from any of the transformer variations summarized in Table 2 below and illustrated in FIGS. 3A-3D.

TABLE 2
Exemplary transformer configurations for use in an MAB converter.

| Transformer | | |
|---|---|---|
| Configuration | FIG. | Description/Variations |
| Transformer Type i | FIG. 3A | Single-phase transformer (302) |
| (300) | | |
| Transformer Type ii | FIG. 3B | Three-phase (or n-phase) |
| (310) | | transformer (star or delta) (312) |
| Transformer Type iii | FIG. 3C | Single-phase matrix transformer (322) |
| (320) | | |
| Transformer Type iv | FIG. 3D | Single-phase matrix transformer with |
| (330) | | inversely coupled windings (332) |
| Transformer Type v | Not shown | Three-phase (or n-phase) matrix |
| | | transformer |
| Transformer Type vi | Not shown | Three-phase (or n-phase) zig-zag |
| | | transformer |

Referring to FIG. 3A, a Transformer Type i configuration 300 employing a single-phase multi-port transformer 302 is shown. In some embodiments, the Transformer Type i configuration 300 can offer a relatively simple design and lower cost. For example, the four transformer windings may be made on one or more legs of a single magnetic core.

Referring to FIG. 3B, a Transformer Type ii configuration 310 employing a three-phase multi-port transformer 312 is shown. In the illustrated example, each component transformer of transformer 312 can be interfaced with three-phase RCNs and three-phase bridges. In some embodiments, the three-phase multi-port transformer can be further extended to an n-phase transformer design. In some embodiments, a multi-phase multi-port transformer can process a higher average power with the same volume as a single-phase transformer, thus resulting in higher power density; however, the design and construction of a multi-phase multi-port transformers can be more complex and may require comprehensive optimization. For example, the multi-port three-phase transformer windings can be arranged in star, delta, or zig-zag configurations, based on the desired operating characteristics, interleaving, and/or voltage levels.

Referring to FIG. 3C, a Transformer Type iii configuration 320 employing a single-phase multi-port matrix transformer 322 is shown. In some embodiments, the matrix transformer structure 322 can comprise windings connected in a series-parallel fashion, which may be effective in substantially reducing conduction losses, for example, for high step-down applications comprising low-voltage high-current ports. In some embodiments, the matrix transformer structure 322 can be realized, for example, by placing windings on separate transformer cores, or on separate legs of an integrated multi-leg core. In some embodiments, the matrix transformer structure can be coupled with an appropriate matrix configuration of the resonant networks and semiconductor bridges (e.g., as shown in FIGS. 2C-2D). In some embodiments, the multi-port matrix transformer can be realized in either single-phase or three-phase/multi-phase configurations.

In some embodiments, some of the windings in a matrix transformer structure 332 can be inversely coupled to other windings. This can be used, for example, to reduce the effective turns ratios for high step-down applications, and thus result in lower conduction losses in the transformer windings. FIG. 3D shows an example of this Transformer Type iv configuration 330, where the second port 112-1 (with voltage V_{DC1}) has an inversely-coupled matrix transformer winding. In some embodiments, the inversely coupled windings can be connected in series/parallel for another matrix transformer structure.

While the illustrated examples of FIGS. 3A-3D focus on four ports (e.g., a single AC port 102-1 and three DC ports 112-1, 112-2, and 112-3), embodiments of the disclosed subject matter are not limited thereto. Rather, the number of ports can be increased or decreased without any loss of generality of the proposed configurations. In any of the above-noted transformer configurations, the integrated leakage inductance can be utilized as an inductor in the RCN, thus resulting in a leakage-integrated multi-port transformer. In some embodiments, the transformer geometries can be realized using planar (PCB-based) or non-planar (Litz wire-based) winding configurations, with varying levels of interleaving between windings.

### Exemplary Resonant Coupling Network Configurations

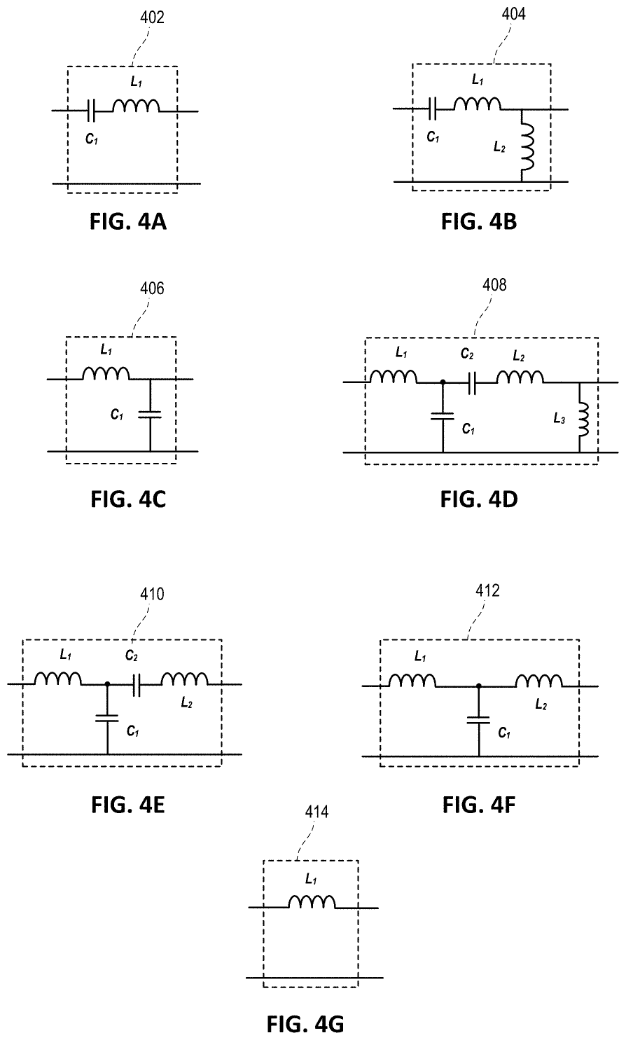

In some embodiments, one or more of the RCN configurations for each port, such as RCN 106 of any of AC ports 102-1 through 102-k and RCN 116 of any of DC ports 112-1 through 112-p, can be selected from any of the topological variations summarized in Table 3 below and illustrated in FIGS. 4A-4G.

In some embodiments, the resonant networks 106, 116 in an MAB converter 100 can be used to effectively modulate the power transfer impedances in the MAB converter, and/or to achieve certain desirable operating characteristics, for example, zero voltage switching (ZVS) and/or zero current switching (ZCS). In some embodiments, the resonant networks for each port can be constructed independently (e.g., such that the resonant network for one port is different than at least one, at least some, or all other ports in the converter with respect to structure and/or component (e.g., L/C) values). In some embodiments, the optimal configuration and L/C values of the resonant network can be determined, for example, using a generalized modeling and universal multi-objective optimization algorithm as described hereinbelow. In some embodiments, the overall resonant networks can be highly asymmetric in nature, based on efficiency, ZVS/ZCS, and/or volume considerations. In some embodiments, any of the disclosed resonant network structures can be transformed into equivalent three-phase structures (e.g., arranged in star or delta fashion).

TABLE 3
Exemplary resonant coupling network (RCN)
configurations for use in an MAB converter.

| | | |
|---|---|---|
| RCN Type | FIG. | Description/Variations |
| RCN Type a | FIG. 4A | LC series resonant (402) |
| RCN Type b | FIG. 4B | CLL resonant (becomes CLLLC) (404) |
| RCN Type c | FIG. 4C | Parallel LC resonant (406) |
| RCN Type d | FIG. 4D | LCCLL resonant (408) |
| RCN Type e | FIG. 4E | LCCL resonant (410) |
| RCN Type f | FIG. 4F | LCL resonant (412) |
| RCN Type g | FIG. 4G | L (inductive non-resonant) (414) |

### Exemplary Circuit Configurations for Multi-Port Power Converters

Based on the generalized configuration of the MAB converter 100 of FIG. 1 and the variations for semiconductor bridge configurations presented in Table 1 and FIGS. 2A-2E, the variations for transformer configurations presented in Table 2 and FIGS. 3A-3D, and the variations for RCN configurations presented in Table 3 and FIGS. 4A-4G, various configurations for a multi-port power converter are possible. Presented hereinbelow are certain examples of circuit configurations for multi-port power converters; however, other configurations are also possible in accordance with the teachings of the present disclosure.

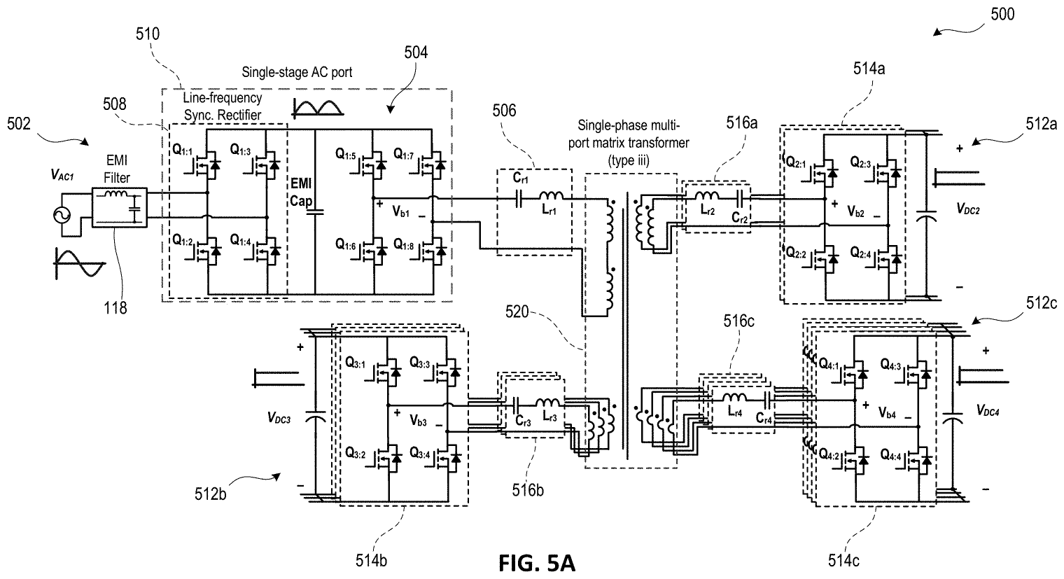

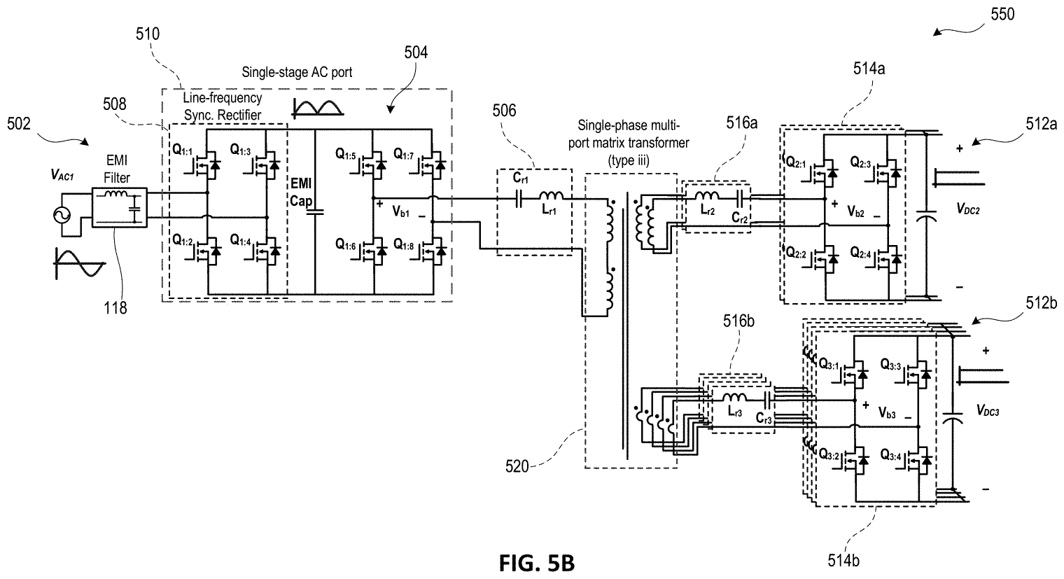

Referring to FIG. 5A, an exemplary circuit configuration 500 for a multi-port active bridge AC-DC resonant converter with matrix transformer is shown. In the illustrated example, the configuration 500 supports four ports—one AC port 502 and three DC voltage ports 512a-512c. However, other numbers of ports are also possible. For example, FIG. 5B shows a variation of FIG. 5A, where circuit configuration 550 supports three ports—one AC port 502 and two DC ports 512a-512b. The AC port 502 can be defined by and/or comprise a single stage AC subsystem 510, which in turn can be defined by and/or comprise a line frequency synchronous rectifier 508 (e.g., Type 1, full bridge) coupled to semiconductor bridge 504 (e.g., Type 1, full bridge). In some embodiments, an EMI filter 118 can be coupled to the rectifier 508 (e.g., between an AC input/output and the single stage AC subsystem 510). The semiconductor bridge 504 can be coupled to transformer 520 (e.g., Type iii, a single-phase multi-port matrix transformer) via RCN 506 (e.g., Type a). Each of the DC ports 512a-512c can be defined by and/or comprise a respective semiconductor bridge 514a-514c (e.g., Type 1, full bridge). Each semiconductor bridge 514a-514c can in turn be coupled to the transformer 520 by respective RCNs 516a-516c (e.g., Type a). In the illustrated example, RCNs 506, 516a-516c have the same configuration (e.g., Type a), although the respective L/C values may be different between the different RCNs. Alternatively, in some embodiments, one, some or all of the RCNs can have different configurations from the others. Similarly, in the illustrated example, bridges 504, 514a-514c have the same configuration (e.g., Type 1). Alternatively, in some embodiments, one, some, or all of the bridges can have different configurations from the others.

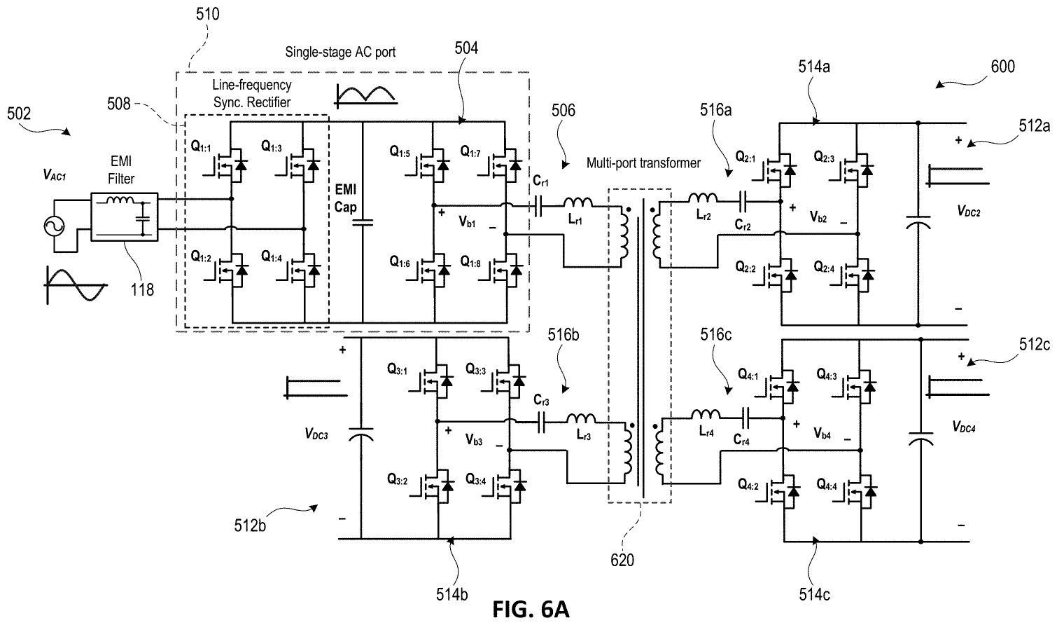

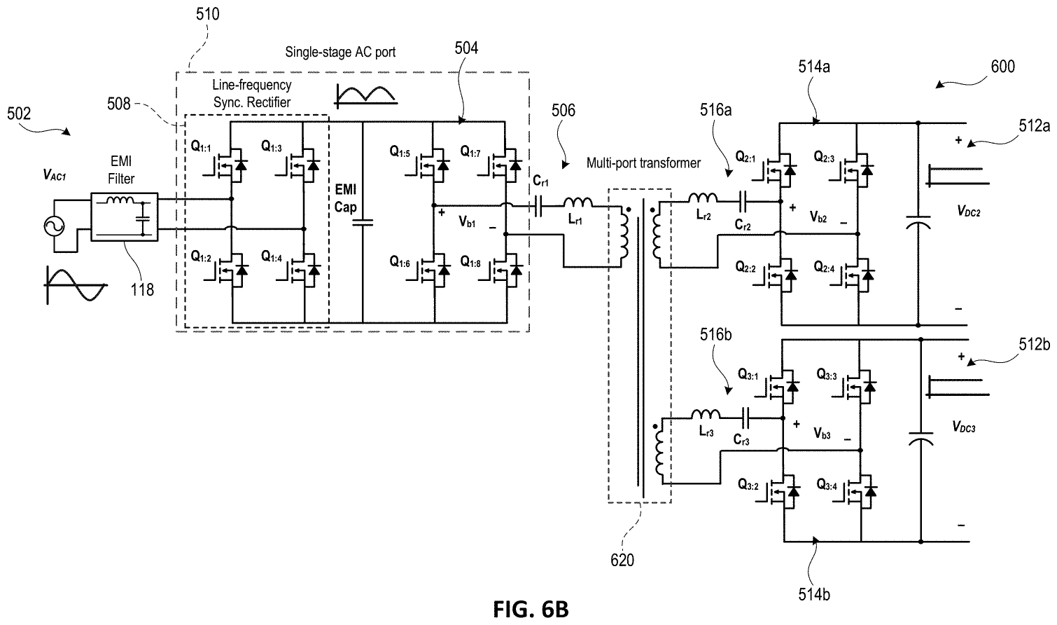

FIG. 6A shows an exemplary circuit configuration 600 for another multi-port active bridge AC-DC resonant converter without back-to-back switches on the AC port. In the illustrated example, the configuration 600 supports four ports—one AC port 502 and three DC voltage ports 512a-512c. However, other numbers of ports are also possible. For example, FIG. 6B shows a variation of FIG. 6A, where circuit configuration 650 supports three ports—one AC port 502 and two DC ports 512a-512b, thus forming a triple-active bridge converter. The AC port 502 can be defined by and/or comprise a single stage AC subsystem 510 similar to FIG. 5A; however, semiconductor bridge 504 can be coupled to transformer 620 (e.g., Type i, a single-phase multi-port transformer) via RCN 506 (e.g., Type a). Each of the DC ports 512a-512c can be defined by and/or comprise a respective semiconductor bridge 514a-514c (e.g., Type 1, full bridge), which are in turn coupled to the transformer 620 by respective RCNs 516a-516c (e.g., Type a).

The configurations of FIGS. 6A-6B may be especially relevant for applications such as, but not limited to, integrated onboard chargers and DC-DC converters for electric vehicles (EVs). Such integrated multi-port power electronic converters interface the AC grid (e.g., coupled to port 502) to the high-voltage (HV) battery (e.g., coupled to port 512a), and one or more low-voltage (LV) batteries (e.g., coupled to ports 512b-512c). As noted above, configurations disclosed herein, including the configuration of FIGS. 6A-6B, can be used to advantage in other applications as well, such as, but not limited to, home energy routers (AC grid and multiple DC voltage buses in homes), data centers, and hybrid energy storage systems.

Starting at an input/output end of the AC voltage port 502 in FIG. 6A, a first sub-system can be defined by and/or comprises EMI filter 118. The first sub-system can be followed by the second subsystem 510, which is defined by and/or comprises line-frequency synchronous rectifier 508 formed by MOSFETs Q1:1, Q1:2, Q1:3, and Q1:4. In operation, the line-frequency rectifier MOSFETs Q1:1 and Q1:3 can turn on when the AC voltage is greater than zero, and the MOSFETs Q1:2 and Q1:4 can turn on when the AC voltage is less than zero. In this single-stage topology, the second subsystem 510 on the AC port 502 does not contain any line-frequency energy storage elements (e.g., inductors or capacitors) and only serves to rectify the AC voltage with a low-frequency switching action. The rectified AC voltage can then be fed to the high-frequency bridge 504 on the first port of the MAB converter. The complete MAB converter topology shown in FIG. 6A is defined by and/or comprises high-frequency H-bridge structures, for example, bridge 504 on port 502 (e.g., Q_{1:5}, Q_{1:6}, Q_{1:7}, and Q_{1:1}), bridge 514a on port 512a (e.g., Q_{2:1}, Q_{2:2}, Q_{2:3}, and Q_{2:4}), bridge 514b on port 512b (e.g., Q_{3:1}, Q_{3:2}, Q_{3:3}, and Q_{3:4}), and bridge 514c on port 512c (e.g., Q_{4:1}, Q_{4:2}, Q_{4:3}, and Q_{4:4}). The high-frequency switch nodes of each bridge 504, 514a-514c are connected to respective RCNs 506, 516a-516c, which can have different configurations of inductors and capacitors (e.g., as discussed with respect to Table 3 hereinabove). The high-frequency ports 502, 512a-512c can be magnetically coupled by the multi-winding transformer 620, which can optionally be designed to have integrated leakage inductances. In some embodiments, control of the MAB converter can be implemented using a single digital signal processor (DSP) microcontroller, multiple DSP microcontrollers, a field-programmable-gate-array-based (FPGA-based) solution.

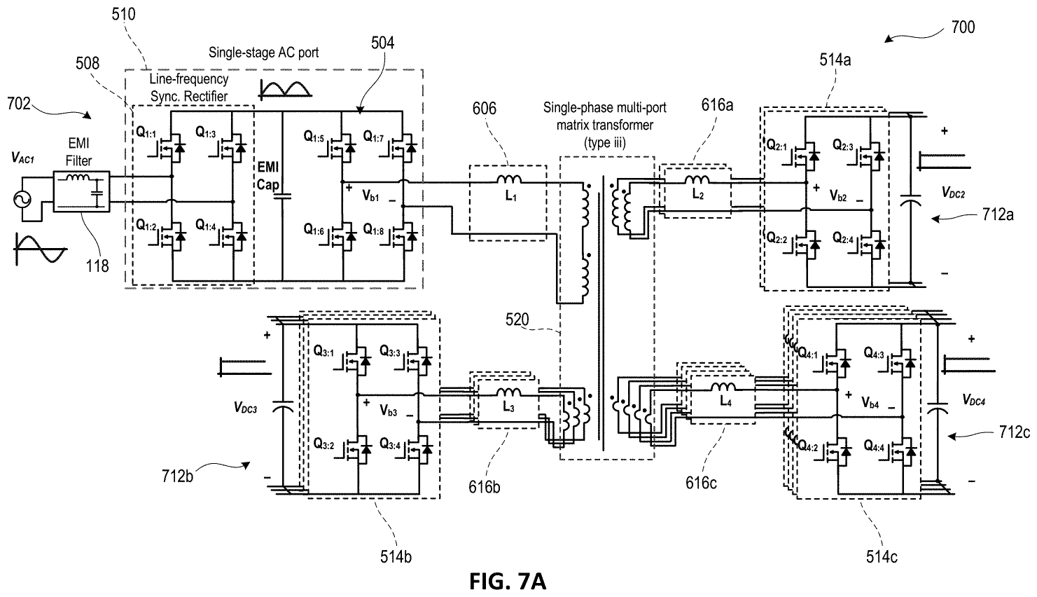

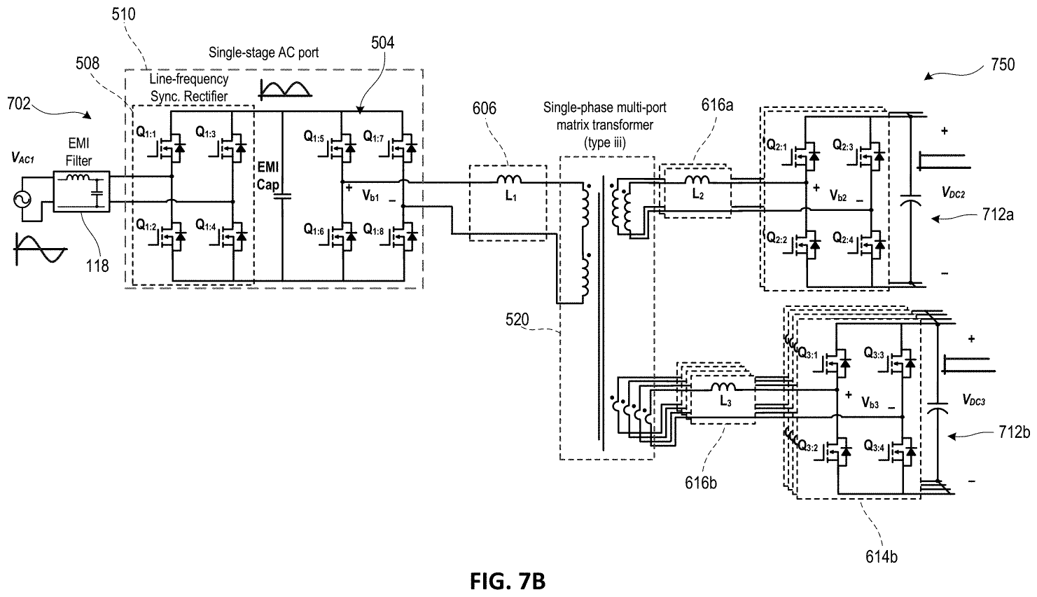

In some embodiments, one or more of the RCNs can be configured to be purely inductive, thus yielding a non-resonant MAB operation. Such a topology would not include any resonant capacitors (labeled as Cᵣ₁, Cᵣ₂, Cᵣ₃, Cᵣ₄ in FIGS. 5A-6B). However, for the purpose of blocking DC voltages, such a topology may include DC-blocking capacitors, which have capacitance values that are a few orders of magnitude greater (e.g., at least 100 times greater than) than capacitance values of resonant capacitors. An example of such a non-resonant (e.g., inductive) multi-port converter configuration 700 with matrix transformer is shown in FIG. 7A. In the illustrated example, the configuration 700 supports four ports—one AC port 702 and three DC voltage ports 712a-712c. However, other numbers of ports are also possible. For example, FIG. 7B shows a variation of FIG. 7A, where circuit configuration 750 supports three ports—one AC port 702 and two DC ports 712a-12b. The AC port 702 can be defined by and/or comprise a single stage AC subsystem 510 similar to FIG. 5A; however, semiconductor bridge 504 can be coupled to transformer 520 (e.g., Type iii, a single-phase multi-port matrix transformer) via coupling network 606 (e.g., Type g, inductor). Each of the DC ports 712a-712c can be defined by and/or comprise a respective semiconductor bridge 514a-514c (e.g., Type 1, full bridge), which are in turn coupled to the transformer 520 by respective coupling networks 614a-616c (e.g., Type g, inductor). In some embodiments, non-resonant MAB converters (e.g., configurations 700, 750 of FIGS. 7A-7B) can offer simpler analysis and a faster design process for a given set of specifications.

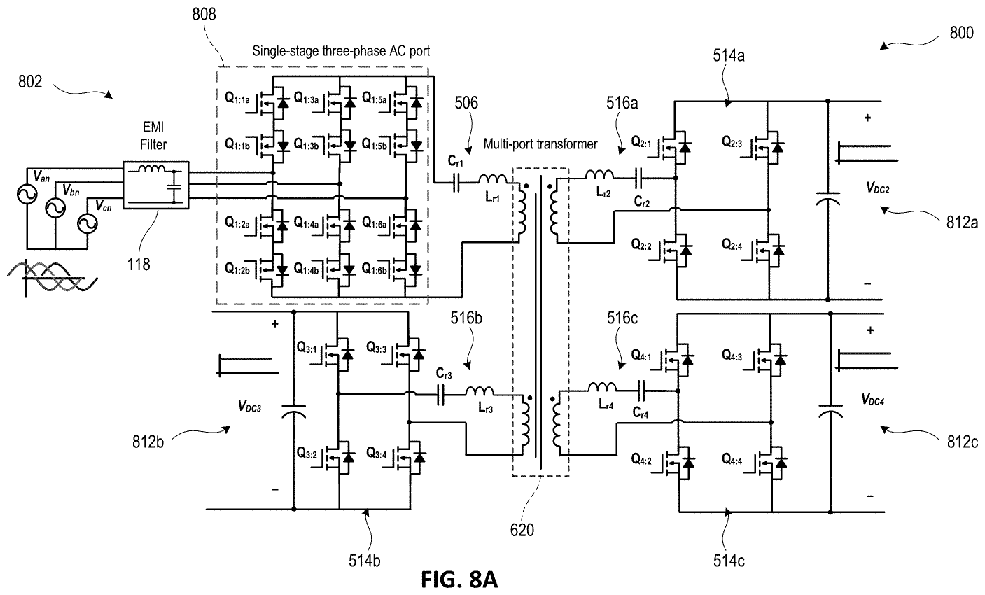

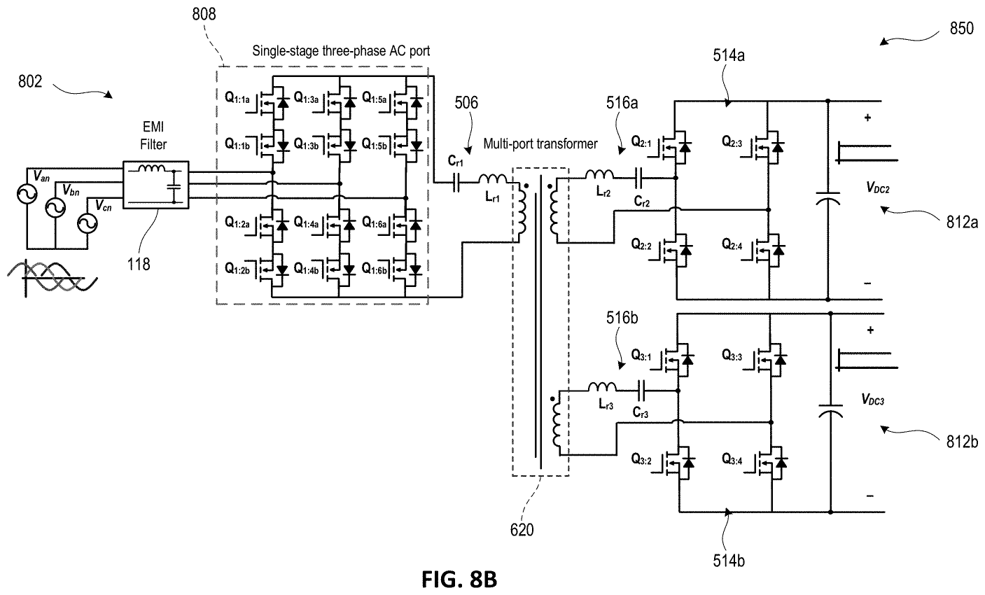

In some embodiments, if a three-phase AC port is to be interfaced to an MAB converter, the indirect single-stage AC front-end (e.g., as illustrated for port 502 in FIG. 5A) can be replaced by a direct single-stage AC port structure, which can be defined by and/or comprise a three-phase bridge with back-to-back switches. For example, FIG. 8A shows an exemplary circuit configuration 800 for a multi-port active bridge AC-DC resonant converter with back-to-back switches on the AC port. In the illustrated example, the configuration 800 supports four ports—one AC port 802 and three DC voltage ports 812a-812c. However, other numbers of ports are also possible. For example, FIG. 8B shows a variation of FIG. 8A, where circuit configuration 850 supports three ports—one AC port 802 and two DC ports 812a-812b. The AC port 802 can be defined by and/or comprise a single-stage three-phase AC subsystem 808. Although a particular semiconductor bridge is illustrated for subsystem 808, other circuit topologies are also possible for interfacing single-phase and three-phase AC ports, for example, as described herein.

The semiconductor bridge of subsystem 808 can be coupled to transformer 620 (e.g., Type i, a single-phase multi-port transformer) via RCN 506 (e.g., Type a). Each of the DC ports 512a-512c can be defined by and/or comprise a respective semiconductor bridge 514a-514c (e.g., Type 1, full bridge). Each semiconductor bridge 514a-514c can in turn be coupled to the transformer 620 by respective RCNs 516a-516c (e.g., Type a). In the illustrated example, RCNs 506, 516a-516c have the same configuration (e.g., Type a), although the respective L/C values may be different between the different RCNs. Alternatively, in some embodiments, one, some or all of the RCNs can have different configurations from the others. Similarly, in the illustrated example, bridges 514a-514c have the same configuration (e.g., Type 1). Alternatively, in some embodiments, one, some, or all of the bridges can have different configurations from the others.

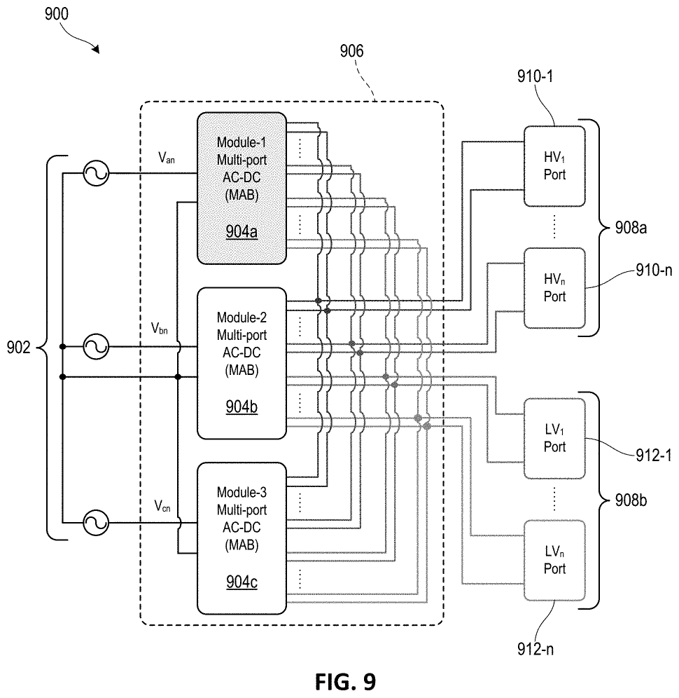

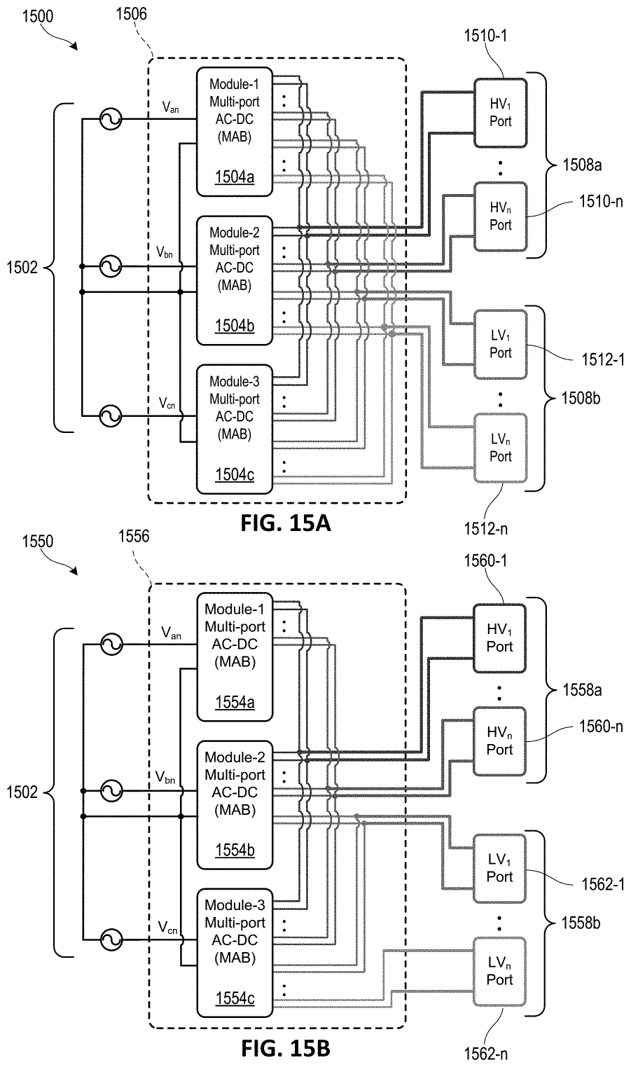

In addition to or in place of the three-phase direct single-stage AC port configurations illustrated in FIGS. 8A-8B, in some embodiments, a parallel connection of single-phase modules can be used to interface the MAB architecture to a three-phase input. For example, FIG. 9 shows an exemplary architecture 900 employing separate single-phase MAB converters 904a-904c (e.g., any of the configurations of FIGS. 5A-7B, 10-14) coupled together in a parallel arrangement 906 to support a three-phase AC port 902 and one or more DC ports. In some embodiments, the DC ports can be divided into a subset 908a of high-voltage ports 910-1 through 910-n (e.g., having a voltage greater than a pre-determined threshold) and a subset 908b of low-voltage ports 912-1 through 912-n (e.g., having a voltage equal to or below the pre-determined threshold). Other modular architectures formed by series and/or parallel connections between various MAB modules are also possible according to one or more contemplated embodiments, for example, as discussed with respect to Table 4 and FIGS. 15A-23B.

FIG. 10 shows an exemplary circuit configuration 1000 for another multi-port active bridge AC-DC resonant converter with back-to-back switches on the AC port. In the illustrated example, the configuration 1000 supports four ports—one AC port 1002 and three DC voltage ports 512a-512c. The AC port 1002 can be defined by and/or comprise a single stage AC subsystem 1010, which uses an H-bridge comprised of back-to-back switches. By using such a configuration, a direct single-stage AC port structure can be realized (in contrast to the indirect single-stage AC port structure of FIGS. 6A-6B). In some embodiments, a direct single-stage AC port structure can allow for tighter packaging of the semiconductor components and/or improved reactive power flow control on the AC port, albeit with a compromise on conduction losses and semiconductor cost. The semiconductor bridge of subsystem 1010 can be coupled to transformer 620 (e.g., Type i, a single-phase multi-port transformer) via RCN 506 (e.g., Type a). Each of the DC ports 512a-512c can be defined by and/or comprise a respective semiconductor bridge 514a-514c (e.g., Type 1, full bridge), which are in turn coupled to the transformer 620 by respective RCNs 516a-516c (e.g., Type a).

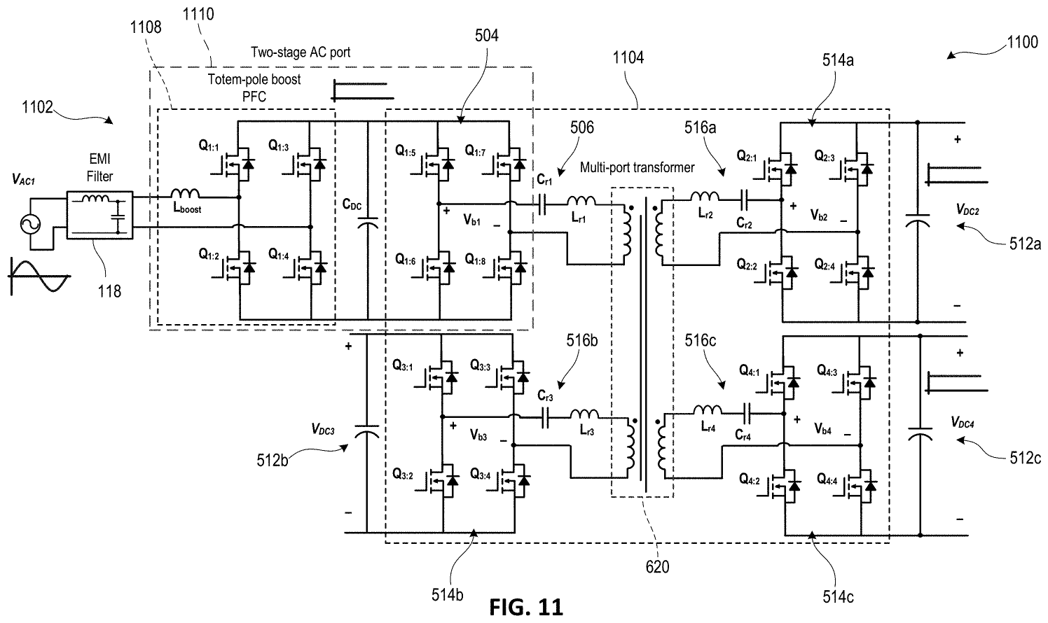

In addition to the single-stage multi-port converters discussed above, in some embodiments, a separate power factor correction (PFC) rectifier stage can be connected to the AC port, for example, before interfacing to the MAB converter. For example, FIG. 11 shows an exemplary circuit configuration 1100 for another multi-port active bridge AC-DC resonant converter with a two-stage AC port. In the illustrated example, the configuration 1100 supports four ports—one AC port 1102 and three DC voltage ports 512a-512c. The AC port 1102 can be defined by and/or comprise a two-stage AC subsystem 1110, which in turn can be defined by and/or comprise a totem-pole boost PFC rectifier 1108 coupled to semiconductor bridge 504 (e.g., Type 1, full bridge). In some embodiments, such a two-stage design on the AC port of the MAB converter can provide a more optimal solution (e.g., with respect to efficiency) under certain design conditions. Unlike the line-frequency synchronous rectifier 508 of FIGS. 5A-5B, the PFC rectifier 1108 of FIG. 11 switches at high-frequency and may require an additional input (e.g., boost) inductor or output (e.g., buck) inductor. Although the example of FIG. 11 illustrates a particular topology for PFC rectifier 1108, embodiments of the disclosed subject matter are not limited thereto. Rather, other topology variations for the PFC rectifier can also be used according to one or more contemplated embodiments.

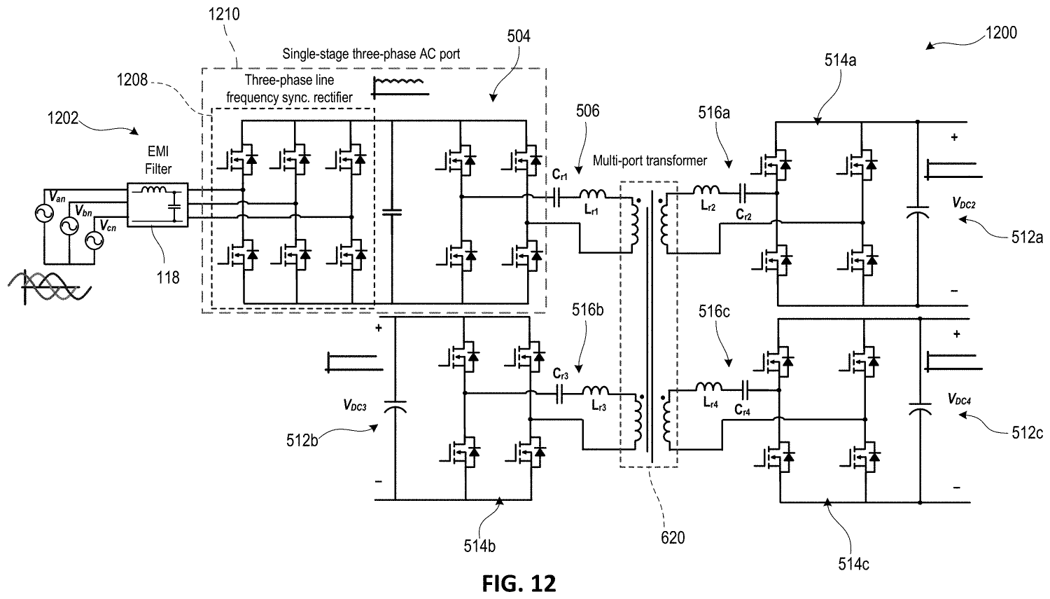

FIG. 12 shows an exemplary circuit configuration 1200 for another multi-port active bridge AC-DC resonant converter without back-to-back switches for a three-phase AC port. In the illustrated example, the configuration 1200 supports four ports—one AC port 1202 and three DC voltage ports 512a-512c. The AC port 1202 can be defined by and/or comprise a single-stage three-phase AC subsystem 1210, which in turn can be defined by and/or comprise a three-phase line frequency synchronous rectifier 1208 (e.g., Type 5, three-phase two-level bridge) coupled to semiconductor bridge 504 (e.g., Type 1, full bridge). In such a configuration, the three-phase AC input can be interfaced using the rectifier 1208 as an indirect single-stage AC front-end synchronous rectifier. By interfacing the three-phase input, the effective AC port voltage appearing across the high-frequency bridge can vary over a narrower range, thus allowing for better component utilization and efficient operation at higher power levels. In some embodiments, the three-phase input interface can be flexibly operated with single-phase AC input, for example, by disabling certain switches.

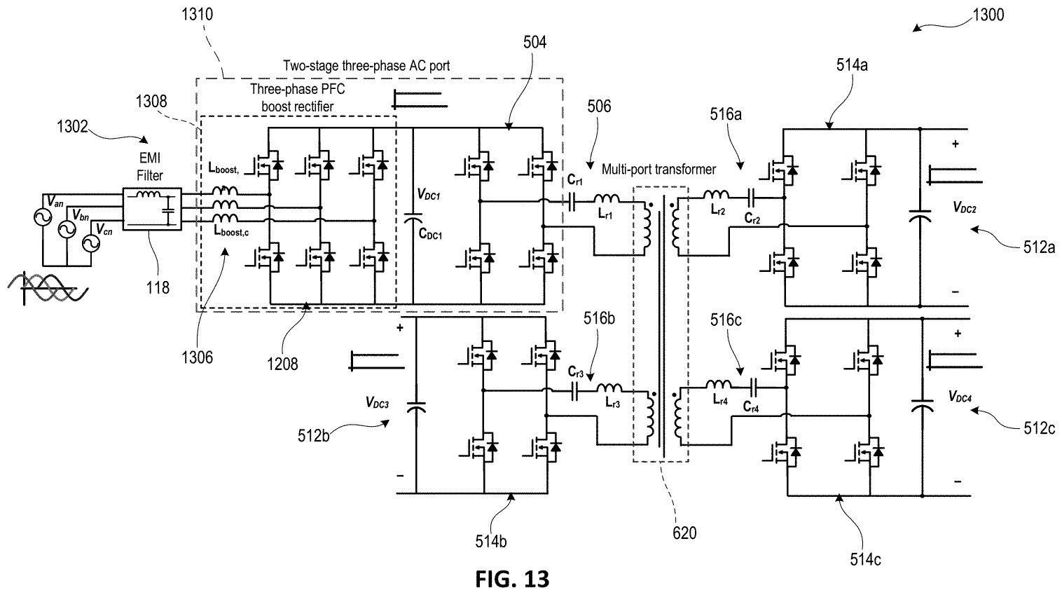

In addition to or in place of the single-stage AC conversion port of FIG. 12, in some embodiments, a three-phase AC port can be interfaced using a two-stage conversion structure. For example, FIG. 13 shows an exemplary circuit configuration 1300 for another multi-port active bridge AC-DC resonant converter with a two-stage AC port. In the illustrated example, the configuration 1300 supports four ports—one AC port 1302 and three DC voltage ports 512a-512c. The AC port 1302 can be defined by and/or comprise a two-stage AC subsystem 1310, which in turn can be defined by and/or comprise a three-phase boost PFC rectifier 1308 (e.g., semiconductor bridge 1208 coupled to respective boost inductors 1306) coupled to semiconductor bridge 504 (e.g., Type 1, full bridge). The interface between rectifier 1308 and semiconductor bridge 504 can be DC, such that the remaining portions of the circuit configuration 1300 (e.g., bridges 504, 514a-514c, RCNs 506, 516a-516c, and transformer 620) operate in effect as a multi-port DC-DC MAB converter. In some embodiments, by using a separate three-phase PFC rectifier 1308, the control can be greatly simplified, albeit at a cost of reduced power density. Although the example of FIG. 13 illustrates a particular topology for PFC rectifier 1308, embodiments of the disclosed subject matter are not limited thereto. Rather, other topology variations for the PFC rectifier can also be used according to one or more contemplated embodiments.

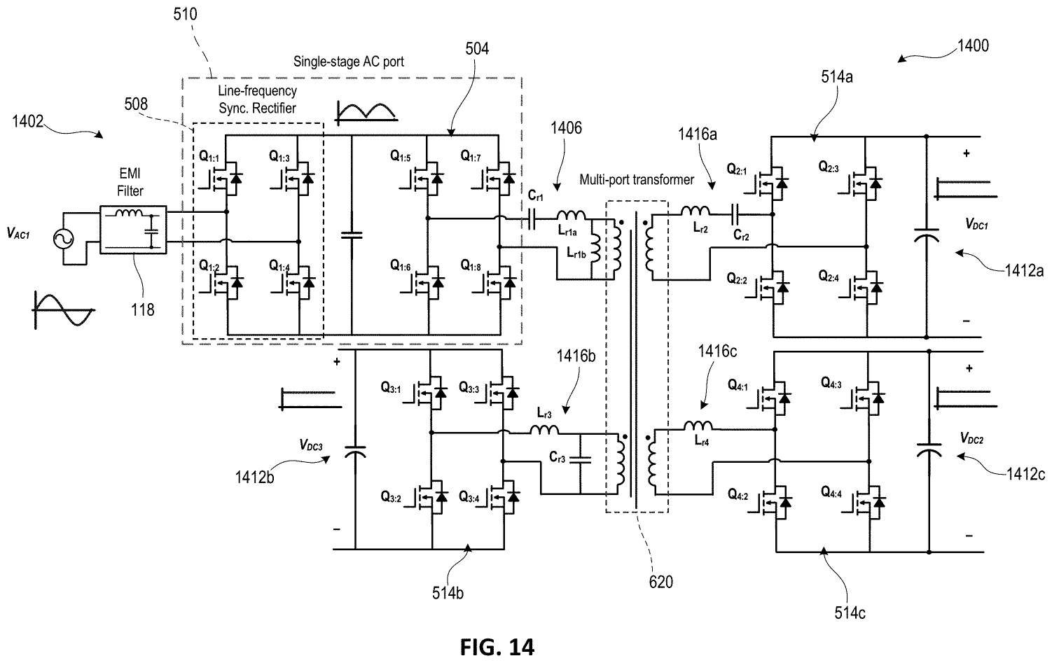

In some embodiments, the MAB converter can have asymmetric resonant networks, e.g., where one, some, or all of RCNs interfacing the semiconductor bridge of a port to the transformer have a different configuration than others of the RCNs. For example, based on a voltage variation range and power levels of various ports, the RCNs can be individually tuned to obtain more optimal performance over an entirety (or at least part of) of an operating range. For example, FIG. 14 shows an exemplary circuit configuration 1400 for a multi-port active bridge AC-DC resonant converter without back-to-back switches on the AC port and having asymmetric RCNs. In the illustrated example, the configuration 1400 supports four ports—one AC port 1402 and three DC voltage ports 1412a-1412c.

The AC port 1402 can be defined by and/or comprise a single stage AC subsystem 510, which in turn can be defined by and/or comprise a line frequency synchronous rectifier 508 (e.g., Type 1, full bridge) coupled to semiconductor bridge 504 (e.g., Type 1, full bridge). EMI filter 118 can be coupled to the rectifier 508 (e.g., between an AC input/output and the single stage AC subsystem 510), and semiconductor bridge 504 can be coupled to transformer 620 (e.g., Type i, a single-phase multi-port transformer) via RCN 1406 (e.g., Type b). Each of the DC ports 1412a-1412c can be defined by and/or comprise a respective semiconductor bridge 514a-514c (e.g., Type 1, full bridge). Each semiconductor bridge 514a-514c can in turn be coupled to the transformer 620 by RCN 1416a (e.g., Type a), RCN 1416b (e.g., Type c), and RCN 1416c (e.g., Type g), respectively. Thus, each of the RCNs 1406, 1416a-1416c has a different configuration, thereby yielding a fully asymmetric resonant configuration. However, in some embodiments, the asymmetry may be applied to less than all of the ports, with the other ports remaining symmetric (e.g., DC ports having the same RCN type while AC ports having a different RCN type from the DC ports).

### Exemplary Modular Architecture Configurations

In some embodiments, an MAB converter can form a self-sufficient unit (e.g., providing power conversion between multiple ports for single-phase AC, three-phase AC, and/or DC applications). Alternatively or additionally, in some embodiments, multiple MAB converters can be connected together (e.g., in series or in parallel) to form a modular architecture. In some embodiments, such modular architectures can offer certain advantages such as, but not limited to, increased failure tolerance and redundancy, higher power handling capability with improved efficiency, easier maintenance with easily swappable modules, and automatic cancellation of a pulsating power ripple in three-phase systems.

In some embodiments, one or more MAB converters (e.g., modules) can be coupled together in any of the modular architecture configurations summarized in Table 4 below and illustrated in FIGS. 15A-23B. While the illustrated examples of FIGS. 15A-23B focus on one AC port (e.g., three-phase AC port 1502, or single-phase AC port 2002) and up to four DC ports (e.g., high-voltage ports 1510-1, 1510-n and low-voltage ports 1512-1, 1512-n in FIG. 15A and corresponding ports in FIGS. 15B-23B), the disclosed modular architecture configurations can be adapted to any number of ports (e.g., AC, DC, or both) higher or lower. Moreover, although specific configurations have been illustrated in FIGS. 15A-23B, other unique configurations are also possible and can be derived by one of skill in the art based on the teachings presented herein.

Referring to FIG. 15A, an exemplary configuration 1500 for Modular Architecture 1 is shown. The configuration 1500 comprises a symmetric 3-phase system 1502 with modular MAB converters 1504a-1504c, each having a single-phase AC input. With a balanced three-phase system, any pulsating AC power ripples on all DC ports 1508a-1508b can be automatically cancelled, thus resulting in very small DC capacitor sizes. Additionally, configuration 1500 can offer sufficient redundancy, wherein the failure of one module 1504a-1504c does not impact the state of power delivery to any of the ports. In some embodiments, the DC ports can be divided into a subset 1508a of high-voltage ports 1510-1 through 1510-n (e.g., having a voltage above a pre-determined threshold) and a subset 1508b of low-voltage ports 1512-1 through 1512-n (e.g., having a voltage equal to or below the pre-determined threshold). For example, Modular Architecture 1 could be used for a smart energy router for DC distribution in homes, where the AC port 1502 is connected to the electrical power grid, an HV₁ port 1510-1 can be a 400 V port, an HVₙ port 1510-n can be a 48 V port, and an LV₁ port 1512-1 can be a 12 V port.

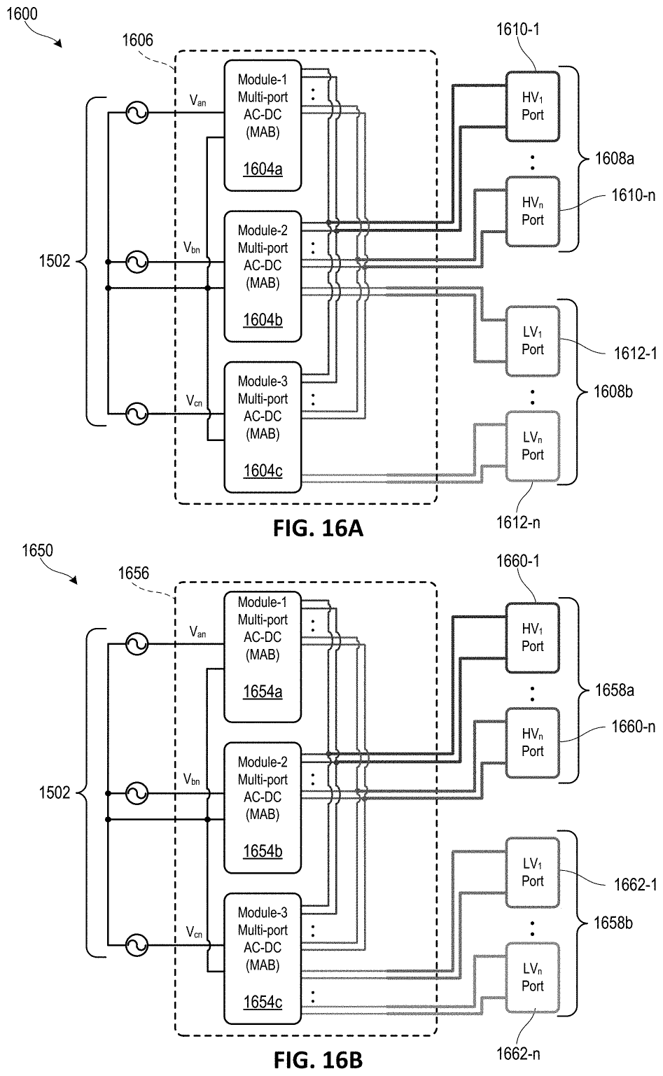

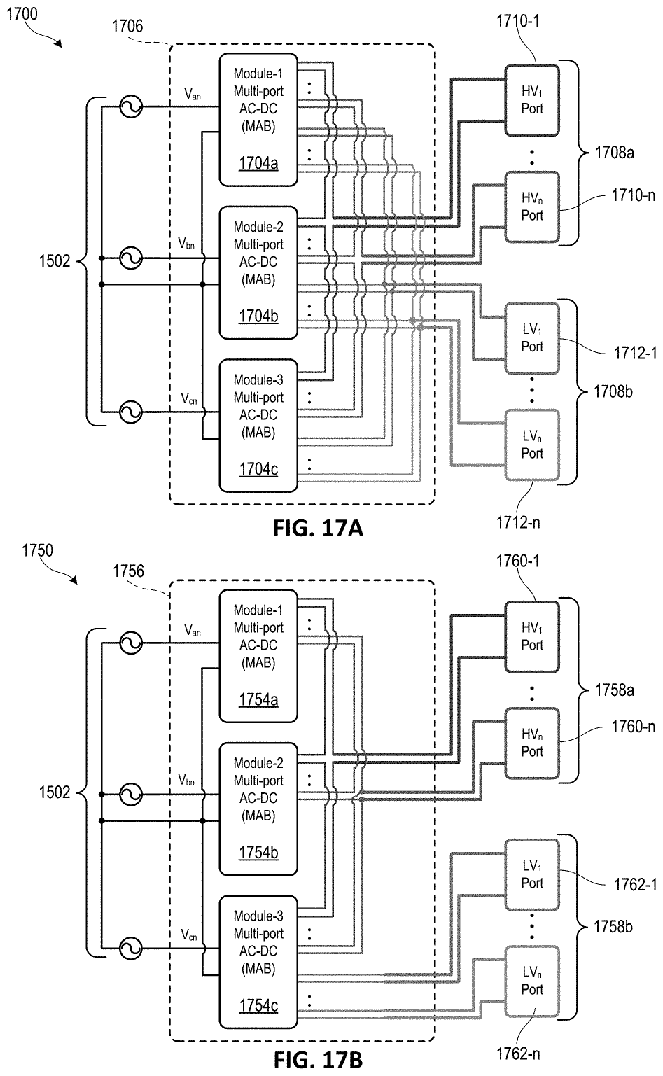

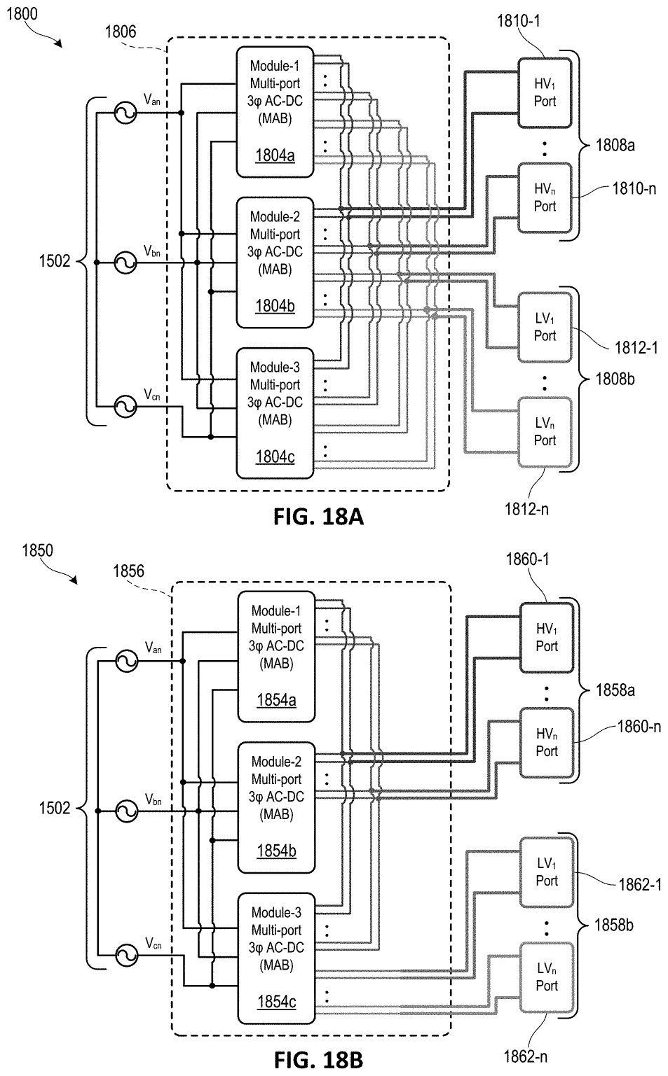

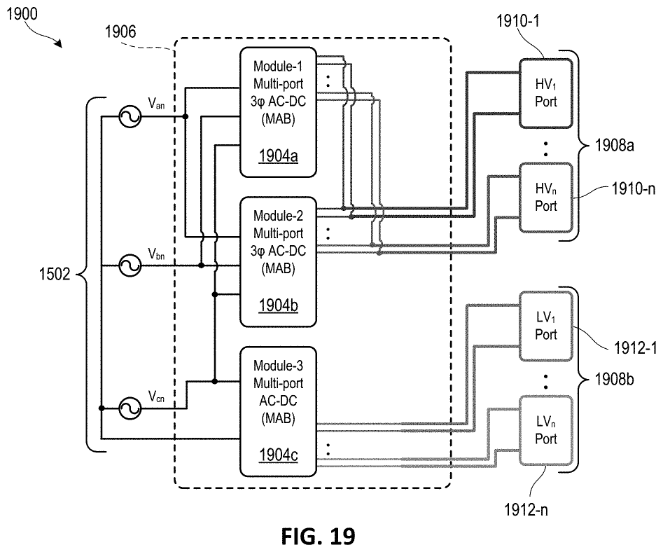

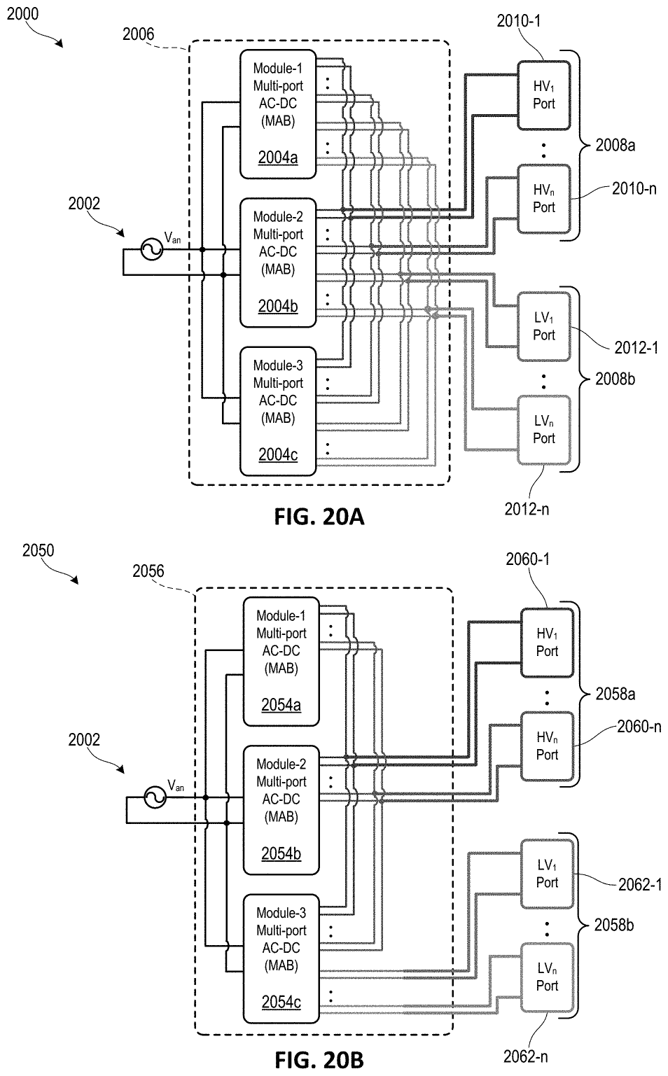

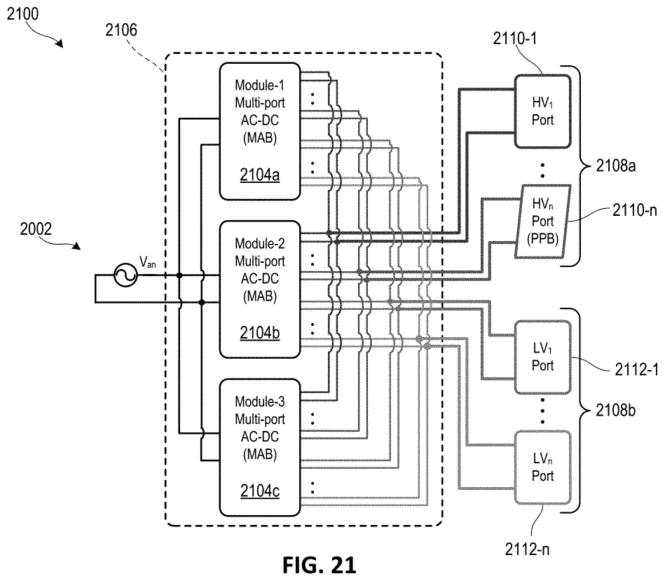

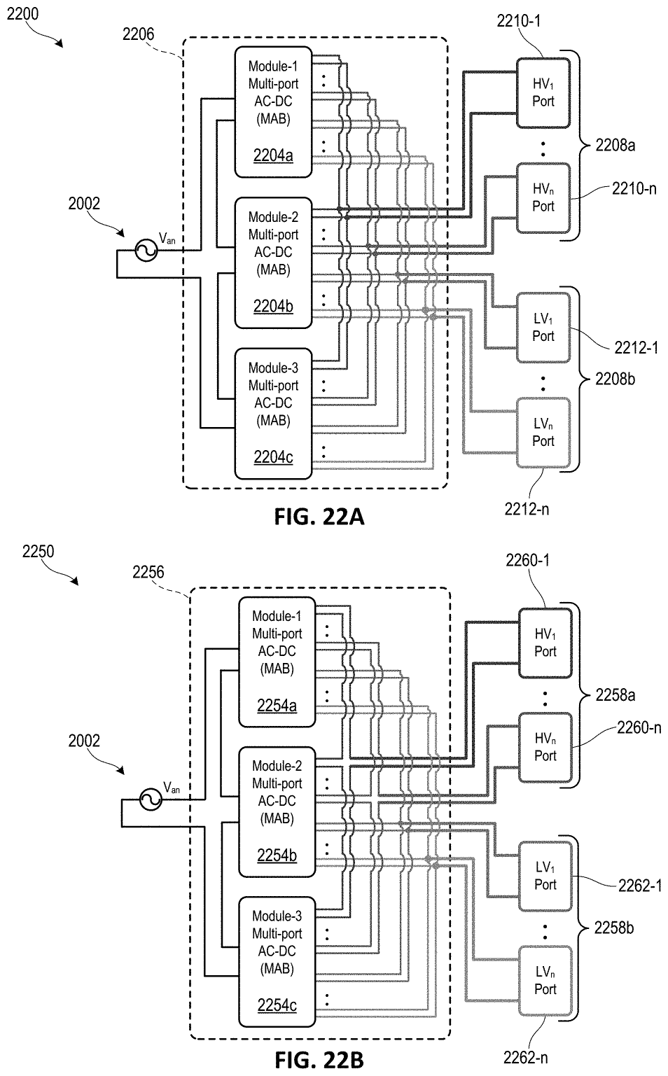

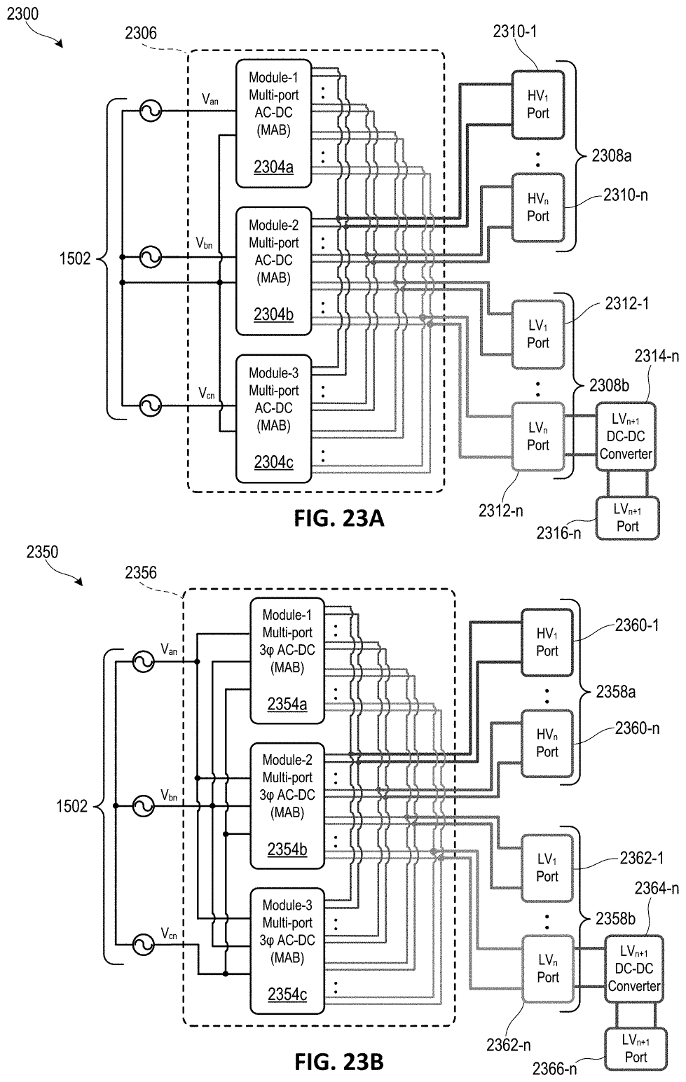

TABLE 4
Exemplary modular architectures constructed using an MAB converter

| | | Description/Variations | | |
|---|---|---|---|---|
| Modular | | | Module AC | |
| Architecture | FIG. | AC System Type | Port Type | Module Description |
| Architecture 1 | FIG. 15A | 3-phase (1502) | 1-phase (1504a-c) | Symmetric parallel MAB |
| (1500) | | | | (1506) |
| Architecture 2 | FIG. 15B | 3-phase (1502) | 1-phase (1554a-c) | Asymmetric parallel MAB |
| (1550) | | | | (1556) |
| Architecture 3 | FIG. 16A | 3-phase (1502) | 1-phase (1604a-c) | Asymmetric parallel MAB |
| (1600) | | | | (1606) |
| Architecture 4 | FIG. 16B | 3-phase (1502) | 1-phase (1654a-c) | Asymmetric parallel MAB |
| (1650) | | | | (1656) |
| Architecture 5 | FIG. 17A | 3-phase (1502) | 1-phase (1704a-c) | Symmetric MAB |
| (1700) | | | | (series/parallel on DC ports) |
| | | | | (1706) |
| Architecture 6 | FIG. 17B | 3-phase (1502) | 1-phase (1754a-c) | Asymmetric MAB |
| (1750) | | | | (series/parallel on DC ports) |
| | | | | (1756) |
| Architecture 7 | FIG. 18A | 3-phase (1502) | 3-phase (1804a-c) | Symmetric parallel MAB |
| (1800) | | | | (1806) |
| Architecture 8 | FIG. 18B | 3-phase (1502) | 3-phase (1854a-c) | Asymmetric parallel MAB |
| (1850) | | | | (1856) |
| Architecture 9 | FIG. 19 | 3-phase (1502) | 3-phase, 1-phase | Asymmetric parallel MAB |
| (1900) | | | asymmetric | (1906) |
| | | | (1904a-c) | |
| Architecture 10 | FIG. 20A | 1-phase (2002) | 1-phase (2004a-c) | Symmetric parallel MAB |
| (2000) | | | | (2006) |
| Architecture 11 | FIG. 20B | 1-phase (2002) | 1-phase (2054a-c) | Asymmetric parallel MAB |
| (2050) | | | | (2056) |
| Architecture 12 | FIG. 21 | 1-phase (2002) | 1-phase (2104a-c) | Symmetric parallel MAB |
| (2100) | | | | with PPB (2106) |
| Architecture 13 | FIG. 22A | 1-phase (2002) | 1-phase (2204a-c) | Symmetric MAB (series on |
| (2200) | | | | AC port, parallel on DC |
| | | | | ports) (2206) |
| Architecture 14 | FIG. 22B | 1-phase (2002) | 1-phase (2254a-c) | Asymmetric MAB |
| (2250) | | | | (series/parallel on AC, DC |
| | | | | ports) (2256) |
| Architecture 15 | FIG. 23A | 3-phase (1502) | 1-phase (2304a-c) | Symmetric parallel MAB |
| (2300) | | | | with cascaded DC-DC |
| | | | | converters (2306) |
| Architecture 16 | FIG. 23B | 3-phase (1502) | 3-phase (2354a-c) | Symmetric parallel MAB |
| (2350) | | | | with cascaded DC-DC |
| | | | | converters (2356) |

Referring to FIG. 15B, an exemplary configuration 1550 for Modular Architecture 2 is shown. The configuration 1550 comprises a three-phase AC input 1502 with modular single-phase input MAB converters 1554a-1554c, similar to configuration 1500. However, the MAB module construction and loadings are asymmetric in the configuration 1550 of FIG. 15B. Such asymmetric designs can result in better optimization of the MAB converters, thus leading to improved overall efficiency and power density. In some embodiments, the DC ports can be divided into a subset 1558a of high-voltage ports 1560-1 through 1560-n (e.g., having a voltage above a pre-determined threshold) and a subset 1558b of low-voltage ports 1562-1 through 1562-n (e.g., having a voltage equal to or below the pre-determined threshold). For example, Modular Architecture 2 could be used for onboard charger applications in electric vehicles, where the AC port 1502 is connected to the electrical power grid, an HV₁ port 1560-1 represents the high-voltage battery (e.g., 400V), an HVₙ port 1560-n represents a 48 V energy storage, an LV₁ port 1562-1 is a 12 V battery, and an LVₙ port 1562-n is a 5 V port for auxiliary electronics.

An exemplary configuration 1600 for Modular Architecture 3 is shown in FIG. 16A, and an exemplary configuration 1650 for Modular Architecture 4 is shown in FIG. 16B. Similar to configuration 1550, Modular Architecture 3 configuration 1600 comprises a three-phase AC input 1502 with modular single-phase input MAB converters 1604a-1604c, and Modular Architecture 4 configuration 1650 comprises a three-phase AC input 1502 with modular single-phase input MAB converters 1654a-1654c. Modular Architectures 3 and 4 thus represent other asymmetric loading versions with a 3-phase AC input connected to modular 1-phase input MAB converters. In some embodiments, the DC ports in configuration 1600 can be divided into a subset 1608a of high-voltage ports 1610-1 through 1610-n (e.g., having a voltage above a pre-determined threshold) and a subset 1608b of low-voltage ports 1612-1 through 1612-n (e.g., having a voltage equal to or below the pre-determined threshold), and/or the DC ports in configuration 1650 can be divided into a subset 1658a of high-voltage ports 1660-1 through 1660-n (e.g., having a voltage above a pre-determined threshold) and a subset 1658b of low-voltage ports 1662-1 through 1662-n (e.g., having a voltage equal to or below the pre-determined threshold). In the Modular Architecture 4 configuration 1650 of FIG. 16B, all of the LV DC ports 1658b can be exclusively interfaced to one MAB module 1654c. For example, such an interface may allow for further optimization of the converter design for efficiency and power density, at the cost of reduced redundancies and a relatively higher imbalance of power at the 3-phase AC port 1502.

While the above-discussed configurations of Modular Architectures 1-4 illustrate parallel connection of MAB converter modules to the DC ports, in some embodiments, the MAB converter modules can instead be connected in series. For example, FIG. 17A illustrates an exemplary configuration 1700 for Modular Architecture 5 employing series connections. The configuration 1700 comprises a symmetric 3-phase system 1502 with modular MAB converters 1704a-1704c, each having a single-phase AC input. By the series connection of modules, the effective voltage rating required for each module 1704a-1704c can be reduced, which may be useful, for example, in applications with higher bus voltages (e.g., 800 V DC bus for the next-generation electric vehicles). In some embodiments, voltage sharing among modules 1704a-1704c can be achieved by load sharing, for example, using a closed-loop control system (e.g., as described in further detail hereinbelow). In some embodiments, with properly selected and matched converter parameters, inherent voltage sharing among series-connected modules may be possible. In some embodiments, the DC ports can be divided into a subset 1708a of high-voltage ports 1710-1 through 1710-n (e.g., having a voltage above a pre-determined threshold) and a subset 1708b of low-voltage ports 1712-1 through 1712-n (e.g., having a voltage equal to or below the pre-determined threshold).

Referring to FIG. 17B, an exemplary configuration 1750 for Modular Architecture 6 is shown. The configuration 1750 comprises a three-phase AC input 1502 with modular single-phase input MAB converters 1754a-1754c, similar to configuration 1700. However, the MAB module construction and loadings are asymmetric in the configuration 1750 of FIG. 17B. As noted above, such asymmetric designs can result in better optimization of the MAB converters, thus leading to improved overall efficiency and power density. In some embodiments, the DC ports can be divided into a subset 1758a of high-voltage ports 1760-1 through 1760-n (e.g., having a voltage above a pre-determined threshold) and a subset 1758b of low-voltage ports 1762-1 through 1762-n (e.g., having a voltage equal to or below the pre-determined threshold).

In some embodiments, instead of modular MAB converters with single-phase AC input, each MAB converter module can be configured to directly connect to the three-phase AC port. Such three-phase inputs can result in automatic pulsating power ripple cancellation within each MAB module, thus leading to improved transformer and switch utilizations. However, the three-phase AC input port MABs may have a higher device count and/or cost compared to single-phase AC input port MAB converters. For example, FIG. 18A illustrates an exemplary configuration 1800 for Modular Architecture 7 employing such three-phase inputs. The configuration 1800 comprises a symmetric 3-phase system 1502 with modular MAB converters 1804a-1804c, each having a three-phase AC input. In some embodiments, the DC ports can be divided into a subset 1808a of high-voltage ports 1810-1 through 1810-n (e.g., having a voltage above a pre-determined threshold) and a subset 1808b of low-voltage ports 1812-1 through 1812-n (e.g., having a voltage equal to or below the pre-determined threshold).

Referring to FIG. 18B, an exemplary configuration 1850 for Modular Architecture 8 is shown. The configuration 1850 comprises a three-phase AC input 1502 with modular three-phase input MAB converters 1854a-1854c, similar to configuration 1800. However, the MAB module construction and loadings are asymmetric in the configuration 1850 of FIG. 18B. As noted above, such asymmetric designs can result in better optimization of the MAB converters, thus leading to improved overall efficiency and power density. In some embodiments, the DC ports can be divided into a subset 1858a of high-voltage ports 1860-1 through 1860-n (e.g., having a voltage above a pre-determined threshold) and a subset 1858b of low-voltage ports 1862-1 through 1862-n (e.g., having a voltage equal to or below the pre-determined threshold).

In some embodiments, instead of all of the modular MAB converters having either single-phase AC input or three-phase AC input, one or some of the MAB converter modules can be configured for three-phase AC input, and one or some of the MAB converter modules can be configured for single-phase AC input. For example, FIG. 19 illustrates an exemplary configuration 1900 for Modular Architecture 9 employing asymmetrically-loaded MAB converters 1904a-1904c comprising a combination of single-phase and three-phase AC inputs for different modules. In some embodiments, such a configuration may be preferable, for example, due to larger differences in power levels between ports, and therefore can present an improved cost and volume compared to a more symmetric solution. In some embodiments, the DC ports can be divided into a subset 1908a of high-voltage ports 1910-1 through 1910-n (e.g., having a voltage above a pre-determined threshold) and a subset 1908b of low-voltage ports 1912-1 through 1912-n (e.g., having a voltage equal to or below the pre-determined threshold).

Although the examples of Modular Architectures 1-9 employ a 3-phase AC input, embodiments of the disclosed subject matter are not limited thereto. Rather, in some embodiments, a single-phase AC input can be employed according to one or more contemplated embodiments. For example, FIG. 20A illustrates an exemplary configuration 2000 for Modular Architecture 10 employing a single-phase AC input. The configuration 2000 comprises a symmetric parallel single-phase AC input 2002 with modular MAB converters 2004a-2004b each having a single-phase AC input. In some embodiments, the DC ports can be divided into a subset 2008a of high-voltage ports 2010-1 through 2010-n (e.g., having a voltage above a pre-determined threshold) and a subset 2008b of low-voltage ports 2012-1 through 2012-n (e.g., having a voltage equal to or below the pre-determined threshold). FIG. 20B illustrates an exemplary configuration 2050 for Modular Architecture 11 employing a single-phase AC input. The configuration 2050 comprises single-phase AC input 2002 with modular single-phase input MAB converters 2054a-2054b, similar to configuration 2000. However, the MAB module construction and loadings are asymmetric in the configuration 2050 of FIG. 20B. In some embodiments, the DC ports can be divided into a subset 2058a of high-voltage ports 2060-1 through 2060-n (e.g., having a voltage above a pre-determined threshold) and a subset 2058b of low-voltage ports 2062-1 through 2062-n (e.g., having a voltage equal to or below the pre-determined threshold).

The Modular Architectures 10 and 11 represent single-phase AC input configurations with symmetrical and asymmetrical loadings, respectively. While the pulsating power ripple cancellation benefits may not be automatically available in systems employing Modular Architectures 10 or 11, the modular connection may still offer improved failure tolerance, serviceability, and/or efficiency, in some embodiments. Alternatively or additionally, in some embodiments, in order to cancel the pulsating power ripple in a MAB configuration with single-phase input, a high-voltage (HV) power pulsation buffer (PPB) can be used. The PPB can comprise an HV capacitor with a large voltage swing and can be directly interfaced to one of the ports of the MAB converter. By controlling the ripple and power flow from the PPB port, the pulsating power AC ripple can be actively canceled. There is negligible net power flow to the PPB port; rather, only a power flow sufficient to supply the parasitic losses in the PPB capacitor is provided. Modulation and control strategies for such an architecture can be similar to those described elsewhere herein.

In some embodiments, instead of a parallel connection, the MAB converter modules can be connected in series on the AC port. For example, FIG. 22A illustrates an exemplary configuration 2200 for Modular Architecture 13 employing such series connections. The configuration 2200 comprises a symmetric single-phase system 2002 with modular MAB converters 2204a-2204c, each having a single-phase AC input. In some embodiments, the DC ports can be divided into a subset 2208a of high-voltage ports 2210-1 through 2210-n (e.g., having a voltage above a pre-determined threshold) and a subset 2208b of low-voltage ports 2212-1 through 2212-n (e.g., having a voltage equal to or below the pre-determined threshold). Referring to FIG. 22B, an exemplary configuration 2250 for Modular Architecture 14 is shown. The configuration 2250 comprises a single-phase AC input 2002 with modular single-phase input MAB converters 2254a-2254c, similar to configuration 2200. However, the MAB module construction and loadings are asymmetric in the configuration 2250 of FIG. 22B. In some embodiments, the DC ports can be divided into a subset 2258a of high-voltage ports 2260-1 through 2260-n (e.g., having a voltage above a pre-determined threshold) and a subset 2258b of low-voltage ports 2262-1 through 2262-n (e.g., having a voltage equal to or below the pre-determined threshold).

In some embodiments, the series connections on the AC port are possible for both single-phase and three-phase input systems. In some embodiments, these connections can be combined with series/parallel connections on the DC ports, resulting in a truly modular architecture. For example, by appropriately selecting series/parallel connections, the voltage/current/power ratings for the modules can be selected more optimally, resulting in lower cost, lower volume, and/or higher efficiency.

In some embodiments, any of the disclosed Modular Architectures can be compatible with single-stage conversion as well as two-stage conversion at the AC ports. Additionally or alternatively, in some embodiments, two-stage conversion can be adopted on one or more of the DC ports. For example, FIG. 23A illustrates an exemplary configuration 2300 for Modular Architecture 15 employing two-stage conversion at a DC port. The configuration 2300 comprises a symmetric three-phase system 1502 with modular MAB converters 2304a-2304c, each having a single-phase AC input. In some embodiments, the DC ports can be divided into a subset 2308a of high-voltage ports 2310-1 through 2310-n (e.g., having a voltage above a pre-determined threshold) and a subset 2308b of low-voltage ports 2312-1 through 2312-n (e.g., having a voltage equal to or below the pre-determined threshold). A second stage converter 2314-n (e.g., MAB converter or otherwise) is coupled between LV DC port 2312-n and LV DC port 2316-n for providing voltage conversion therebetween.

Referring to FIG. 23B, an exemplary configuration 2350 for Modular Architecture 16 is shown. The configuration 2350 comprises a three-phase AC input 1502 with modular input MAB converters 2354a-2354c, similar to configuration 2300. However, MAB converters 2354-2354c are configured for three phase input in the configuration 2350 of FIG. 23B. In some embodiments, the DC ports can be divided into a subset 2358a of high-voltage ports 2360-1 through 2360-n (e.g., having a voltage above a pre-determined threshold) and a subset 2358b of low-voltage ports 2362-1 through 2262-n (e.g., having a voltage equal to or below the pre-determined threshold). A second stage converter 2364-n (e.g., MAB converter or otherwise) is coupled between LV DC port 2362-n and LV DC port 2366-n for providing voltage conversion therebetween.

Although the second stage converter is associated with a single low-voltage DC port in the illustrated examples of FIGS. 23A-23B, in some embodiments, the second stage converter can be associated with any of the ports and/or multiple second stage converters can be provided. In some embodiments, by utilizing cascaded DC-DC converters for some ports, the design of the MAB converter can be simplified, for example, by reducing the number of ports and/or reducing excessively high or low voltage levels. This may, in turn, lead to more optimal MAB converter designs for certain scenarios.

### Exemplary Operation of MAB Converters

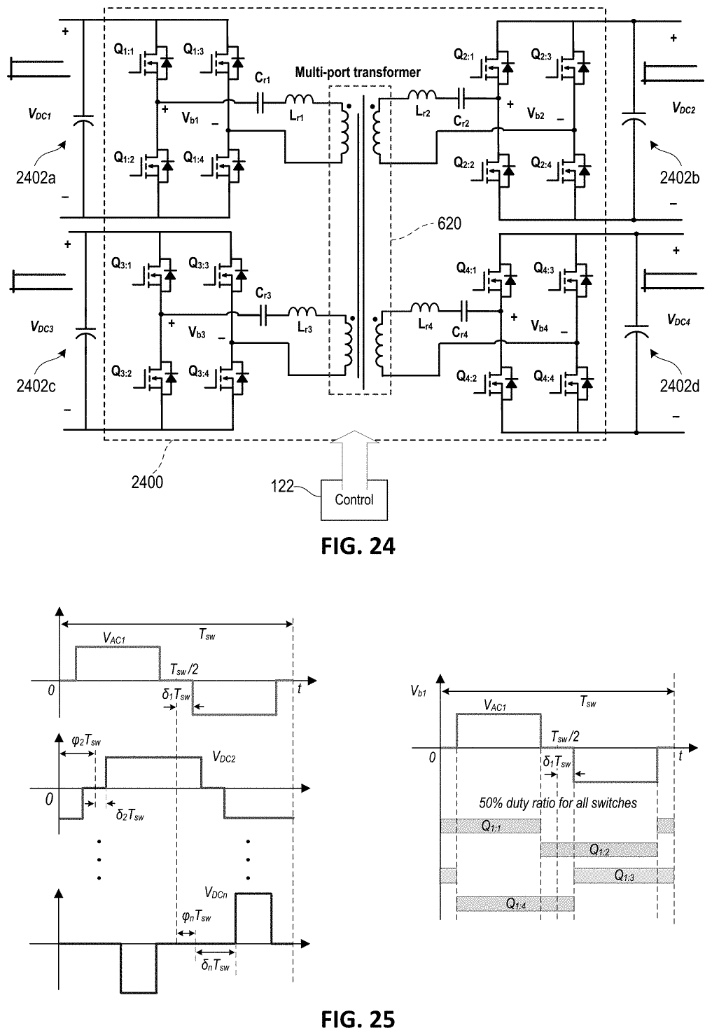

The switching operation of an MAB converter according to any of the disclosed examples can be effected in any number of ways. Presented herein below are exemplary operation methods for a four-port converter; however, the teachings of the present disclosure can be readily generalized to operation of any n-port converter. For example, FIG. 24 illustrates an exemplary four-port resonant MAB converter 2400 supporting four ports, e.g., port 2402a (Q_{1:1}, Q_{1:2}, Q_{1:3}, and Q_{1:4}), port 2402b (Q_{2:1}, Q_{2:2}, Q_{2:3}, and Q_{2:4}), port 2402c (Q_{3:1}, Q_{3:2}, Q_{3:3}, and Q_{3:4}), and port 2402d (Q_{4:1}, Q_{4:2}, Q_{4:3}, and Q_{4:4}). A controller 122 can be operatively coupled to the MAB converter 2400 and configured to control operation thereof, for example, by controlling operations of switches of the various bridges of each port 2402a-2402d. For example, in a first exemplary operating configuration, all the MOSFETs in the high-frequency H-bridges can operate with a 50% duty ratio, with a complimentary switching logic within each H-bridge leg. The switching frequency and the phase shifts between various high-frequency H-bridge legs (equal to ‘n−1’ phase shifts for an n-port MAB) can be adjusted to obtain multiple-active bridge operation. This modulation method can be a combination of phase-shift modulation (PSM) and pulse-frequency modulation (PFM). The phase shifts, as defined for the operation of the generalized MAB converter, are illustrated in FIG. 25.

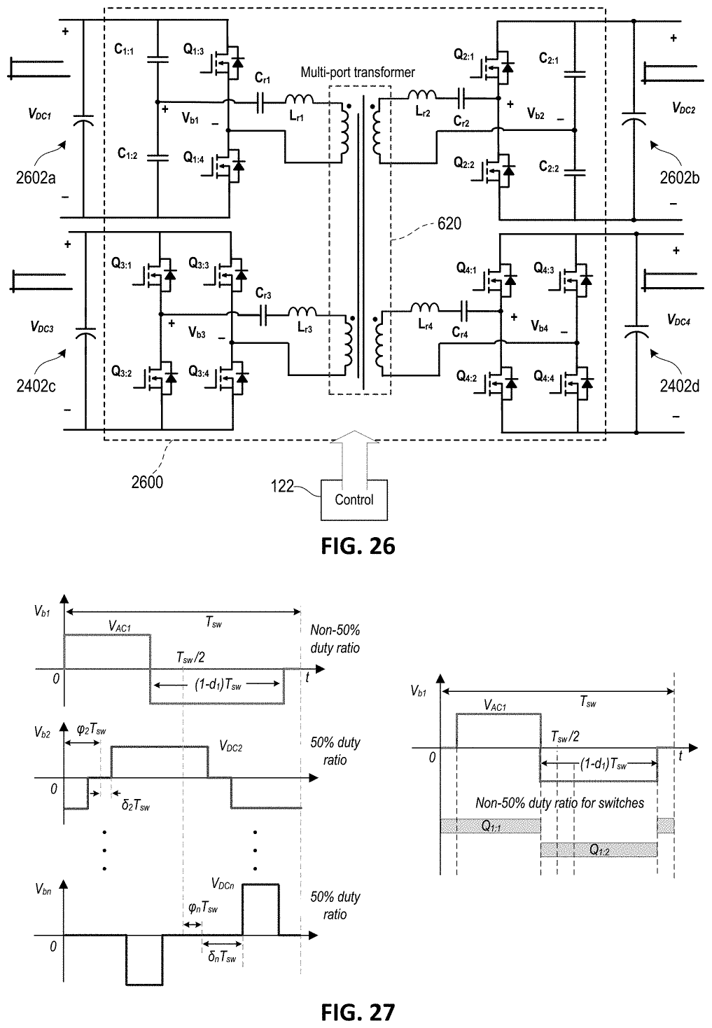

In another exemplary operating configuration, phase-width modulation (PWM) can also be applied, in addition to or in place of PSM and/or PFM. For example, a combination of PWM, PSM, and PFM may be beneficial for circuit topologies comprising half-bridge configurations for certain ports, such as MAB configuration 2600 illustrated in FIG. 26. For example, the MAB converter 2600 of FIG. 26 can support four ports, e.g., port 2602a (C_{1:1}, C_{1:2}, Q_{1:1}, and Q_{1:2}), port 2602b (C_{2:1}, C_{2:2}, Q_{2:1}, and Q_{2:2}), port 2402c (Q_{3:1}, Q_{3:2}, Q_{3:3}, and Q_{3:4}), and port 2402d (Q_{4:1}, Q_{4:2}, Q_{4:3}, and Q_{4:4}). A controller 122 can be operatively coupled to the MAB converter 2600 and configured to control operation thereof, for example, by controlling operations of switches of the various bridges of each port 2602a-2602d. In some embodiments, by applying PWM for half-bridge configurations, an additional degree-of-freedom can be provided for the modulation, which degree-of-freedom can be used to optimize the RMS currents in the transformer and/or improve ZVS performance. For example, in applying PWM, the duty ratio of the top switch in an H-bridge leg can be set to a value different from 50%, and the bottom switch in the same leg can be assigned the complimentary duty ratio. This can result in the asymmetrical multiple-active half-bridge converter topology shown in FIG. 26, while the effective DC voltage can be blocked by the series resonant capacitors Cᵣ₁, Cᵣ₂, Cᵣ₃, and Cᵣ₄. In some embodiments, the presence of series capacitors may be necessary, for example, if the PWM technique is applied in addition to PSM. FIG. 27 illustrates the modulation variables for an exemplary PWM-PSM-PFM hybrid scheme.

In some embodiments, the half bridge port configurations (e.g., as shown in FIG. 26) can be operated without series capacitors, for example, if the duty ratio of both switches in the half-bridge is kept at 50%. Alternatively or additionally, in some embodiments, if PWM operation (e.g., non-50% duty ratio) is desired on a full-bridge port configuration without series capacitors to block DC voltage, it can be realized if the duty ratios of the top switches on both legs are equal (which consequently implies that duty ratios of bottom switches on both legs are also equal) or substantially equal. This can ensure that there is no DC current component flowing in the corresponding transformer winding, which may otherwise cause the transformer to potentially saturate.

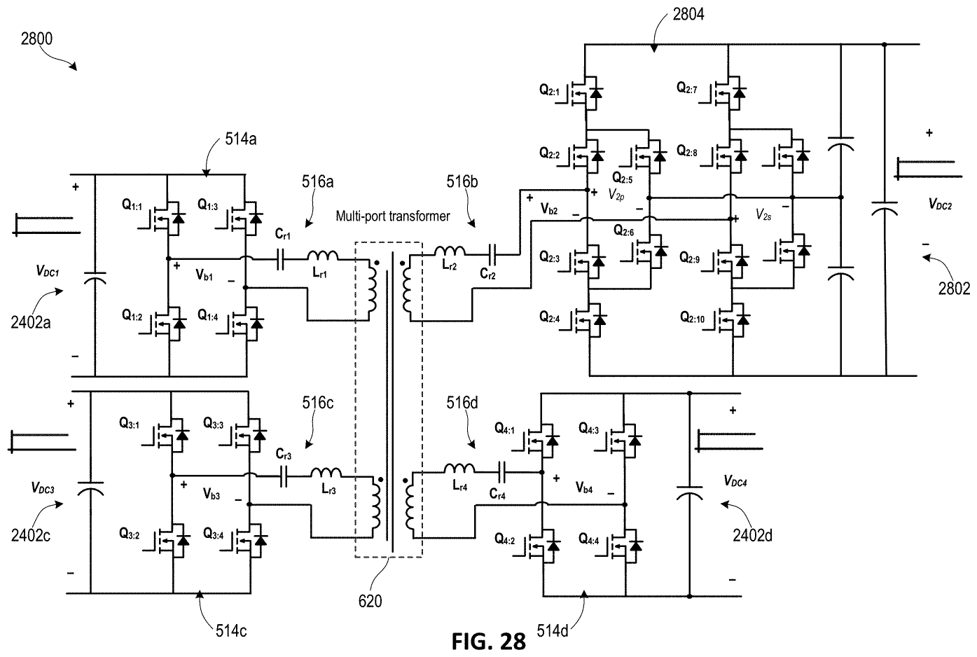

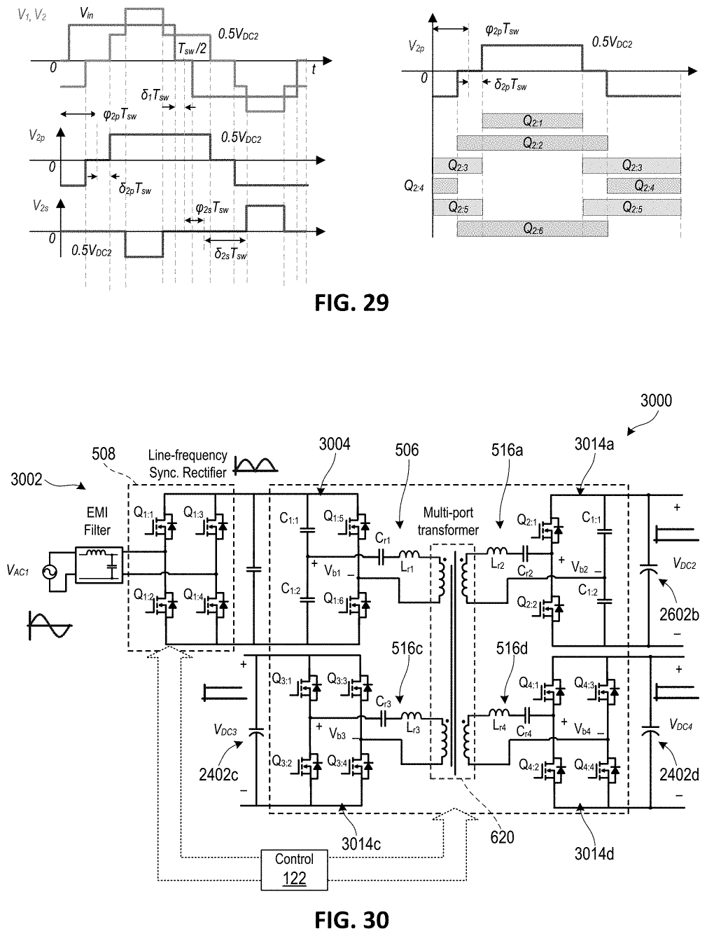

FIG. 28 shows an exemplary circuit configuration 2800 for a multi-port active bridge DC-DC resonant converter with a multi-level ANPC bridge on one port. In the illustrated example, the configuration 2800 supports four DC voltage ports 2402a, 2402c, 2402d, and 2802. DC port 2802 can be defined by and/or comprise a multi-level semiconductor bridge 2804 (e.g., Type 2, m-level ANPC full bridge) coupled to transformer 620 (e.g., Type i, a single-phase multi-port transformer) via RCN 516b (e.g., Type a). Each of the remaining DC ports 2402a, 2402c, 2402d can be defined by and/or comprise a respective semiconductor bridge 514a, 514c, 514d (e.g., Type 1, full bridge), which are in turn coupled to the transformer 620 by respective RCNs 516a, 516c, 516d (e.g., Type a). In such a multi-level bridge 2804, several phase shifts can be introduced between the operation of different switches, for example, as illustrated in FIG. 29. In some embodiments, these phase shifts, along with the switching frequency and duty ratio of each switch, can form an overall modulation scheme of the multilevel bridge in the MAB converter 2800.

Alternatively or additionally, in some embodiments, the PWM, PSM, and/or PFM schemes can be applied to paralleled bridges connected to a matrix transformer, for example as illustrated in FIGS. 7A-7B. In such embodiments, the treatment of the modulation variables can be performed in a manner similar to the bridges described above, with a constraint being that the modulation variables for paralleled bridges on the same port can be set as equal or substantially equal. In some embodiments, the disclosed modulation strategies can be further extended to MAB converters with a single-stage AC port (e.g., either single-phase or three-phase). For example, FIG. 30 illustrates an exemplary circuit configuration 3000 for a multi-port active bridge AC-DC resonant converter without back-to-back switches on the AC port. In the illustrated example, the configuration 3000 supports four ports—one AC port 3002 and three DC voltage ports 2602b, 2402c, and 2402d. The AC port 3002 can be defined by and/or comprise a single stage AC subsystem, which in turn can be defined by and/or comprise a line frequency synchronous rectifier 508 (e.g., Type 1, full bridge) coupled to semiconductor bridge 3004 (e.g., Type 1, half bridge with split capacitor). The semiconductor bridge 3004 can be coupled to transformer 620 (e.g., Type i, a single-phase multi-port transformer) via RCN 506 (e.g., Type a). DC port 2602b can be defined by and/or comprise a semiconductor bridge 3014a (e.g., Type 1, half bridge with split capacitor), which is in turn coupled to the transformer 620 by RCN 516a (e.g., Type a). Each of the remaining DC ports 2402c, 2402d can be defined by a respective semiconductor bridge 3014c, 3014d (e.g., Type 1, full bridge), which are in turn coupled to the transformer 620 by respective RCNs 516c, 516d (e.g., Type a).

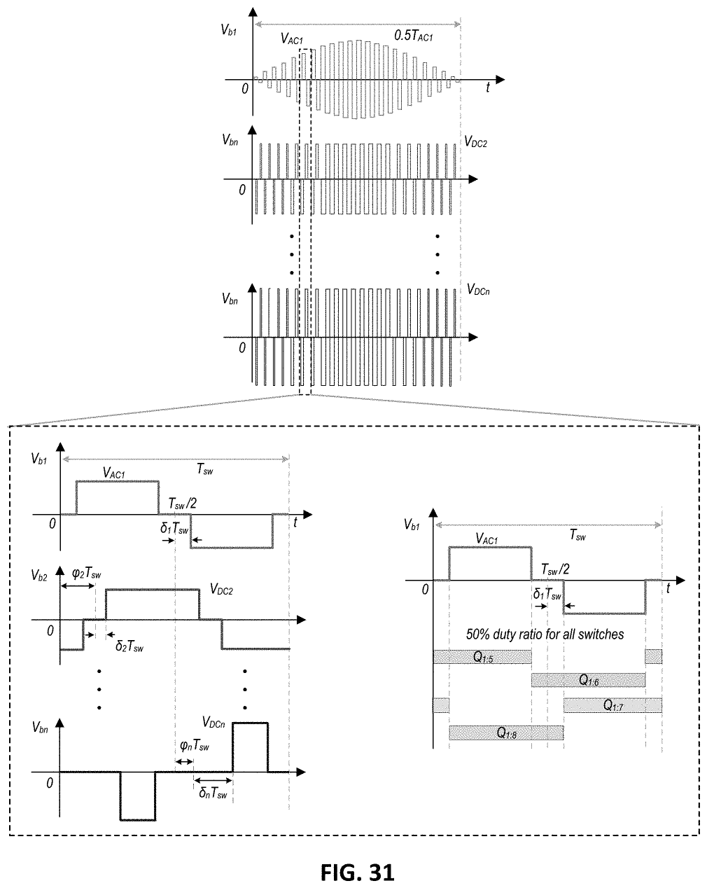

In operation, the MOSFETs Q_{1:1} and Q_{1:3} of line-frequency synchronous rectifier 508 can turn on when the AC voltage is greater than zero, and the MOSFETs Q_{1:2} and Q_{1:4} of rectifier 508 can turn on when the AC voltage is less than zero. This rectifier subsystem 508 does not contain any line-frequency energy storage elements (e.g., inductors or capacitors) and only serves to rectify the AC voltage with a low-frequency switching action. The rectified AC voltage is then fed to the high-frequency bridge 3004 on the first port 3002 of the MAB converter. The process of discretization of the AC line-cycle to extract DC operating points for each switching cycle is illustrated in FIG. 31.

In some embodiments, the above-noted strategies for operation and control of an MAB converter can be applied to MAB converters with three-phase AC ports. Alternatively or additionally, in some embodiments, the modulation strategies disclosed herein can be applied to configurations where one port acts like a power pulsation buffer (PPB), thus neither sinking nor sourcing power in an average sense.

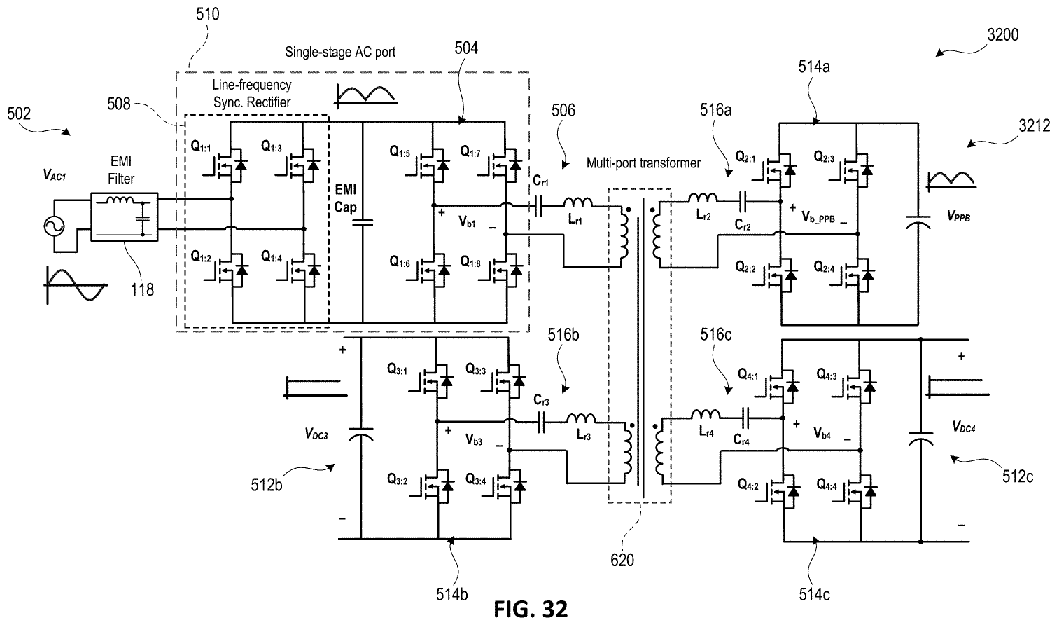

For example, FIG. 32 illustrates an exemplary circuit configuration 3200 for a multi-port active bridge AC-DC resonant converter with an indirect single-stage AC port 502 and a PPB port 3212. Similar to the configuration 600 of FIG. 6A, the AC port 502 can be defined by and/or comprise a single stage AC subsystem 510 coupled to transformer 620 (e.g., Type i, a single-phase multi-port transformer) via RCN 506 (e.g., Type a), and each of the DC ports 512b, 512c can be defined by and/or comprise a respective semiconductor bridge 514b, 514c (e.g., Type 1, full bridge) coupled to the transformer 620 by respective RCNs 516b, 516c (e.g., Type a). The PPB port 3212 can be defined by and/or comprise a semiconductor bridge 514a (e.g., Type 1, full bridge) coupled to the transformer 620 by RCN 516a (e.g., Type a). For example, by controlling the ripple and power flow from the PPB port 3212, any pulsating power AC ripple can be actively canceled. In such embodiments, there may be negligible net power flow to the PPB port 3212, since the power flow is otherwise only sufficient to supply the parasitic losses in the PPB capacitor.

### Exemplary Design and Optimization of MAB Converters

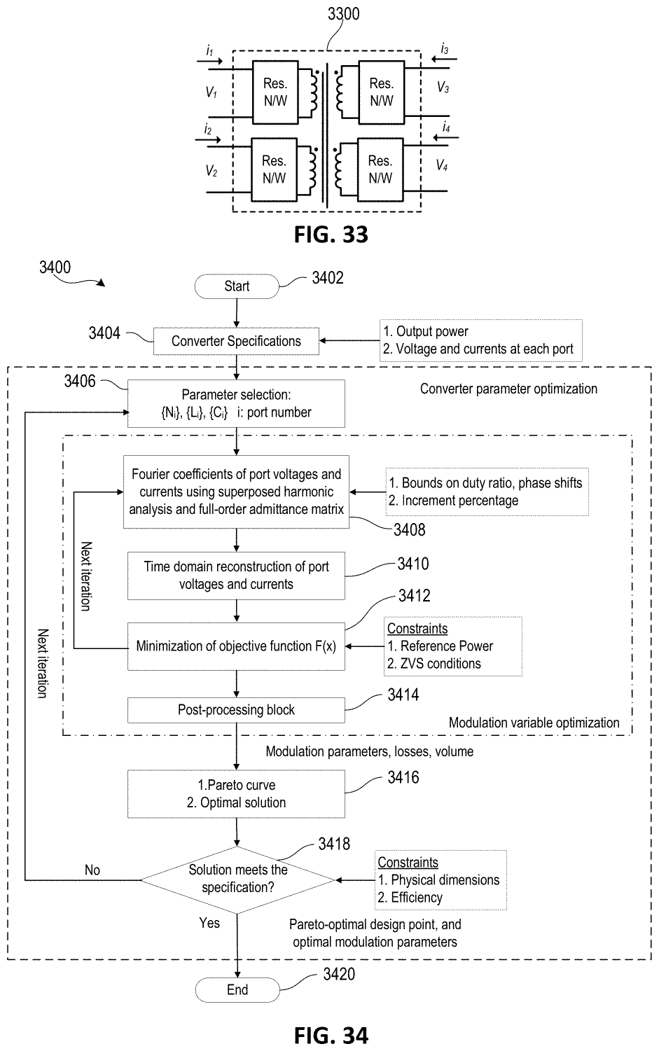

In some embodiments, any of the disclosed examples of MAB converters, or variations thereof according to the teachings of the present disclosure, can be subjected to analysis and/or modeling (e.g., using numerical optimization techniques), for example, to select configurations and component values thereof for a particular application. For example, for a four-port MAB converter, an equivalent network 3300 as shown in FIG. 33 can be used for modeling, which network can be readily extended to n-ports. The voltages and currents for the MAB converter can be expressed in the frequency-domain using Fourier series coefficients. Since the circuit is linear for each frequency component in the frequency domain, a generalized harmonic superposition method can be applied. The k^{th} harmonic voltage at a given n^{th} port can be expressed as follows, with relevant variables defined as in FIG. 33:

$${〈 {v}_{b n} 〉}_{k} = ( \frac{4}{k π} {V}_{n} cos ( 2 k π {δ}_{n} ) ) {e}^{- j 2 k {πφ}_{n}} .$$

Using a voltage Fourier series coefficient at each port, the current components can be computed using the following equation:

[symbol]

i_{bn} [symbol] ₖ=[Zₖ]⁻ [symbol] v_{bn} [symbol] ₖ,

where Zₖ represents the equivalent n-port impedance matrix for the network 3300. The computation of Zₖ can be carried out with the knowledge of the n-port transformer impedance matrix Z_{t,k} and each of the 2-port resonant network impedance matrices Z_{r,n,k}. As an example, the equivalent impedance matrix for a four-port series-resonant MAB converter shown in FIG. 32 can be given by:

$${Z}_{k} = [ \begin{matrix}( jk ω {L}_{r 1} + \frac{1}{jk ω {C}_{r 1}} + {R}_{1} ) & jk ω {M}_{12} & jk ω {M}_{13} & jk ω {M}_{14} \\ jk ω {M}_{21} & ( jk ω {L}_{r 2} + \frac{1}{jk ω {C}_{r 2}} + {R}_{2} ) & jk ω {M}_{23} & jk ω {M}_{24} \\ jk ω {M}_{31} & jk ω {M}_{32} & ( jk ω {L}_{r 3} + \frac{1}{jk ω {C}_{r 3}} + {R}_{3} ) & jk ω {M}_{34} \\ jk ω {M}_{41} & jk ω {M}_{12} & jk ω {M}_{43} & ( jk ω {L}_{r 4} + \frac{1}{jk ω {C}_{r 4}} + {R}_{4} )\end{matrix} ] .$$

Here, Mᵢⱼ refers to the mutual inductance between i^{th} and j^{th} ports of the multi-port transformer; Rᵢ refers to the parasitic resistance present in i^{th} port due to non-idealities in the corresponding transformer port, resonant capacitor, resonant inductor and interconnects (which are not explicitly shown in the figures). Once the voltage and current Fourier series coefficients are known, the real power at the n^{th} port for the k^{th} harmonic component can be directly computed by:

P_{n,k}= [symbol] v_{bn} [symbol] ₖ [symbol] i_{bn} [symbol] ₖ*.

Based on the above analysis, quantities of the MAB converter can be conveniently determined and can be used for modeling, closed-loop control, and/or optimization as detailed below. In addition, the above analysis method is valid for and can be readily extended to all bridge configurations (e.g., as shown in FIGS. 2A-2F), transformer configurations (including three-phase transformers) (e.g., as shown in FIGS. 3A-3D), and resonant network configurations (e.g., as shown in FIGS. 4A-4G). The extension of the analysis for any of the aforementioned semiconductor bridge, transformer, or resonant network configurations is trivial.

Referring to FIG. 34, an exemplary method 3400 for optimization of modulation, multiport transformer, and RCN parameters is shown. The method 3400 can initiate at terminal block 3402 and proceed to process block 3404, where the converter specifications are provided as inputs to determine the optimal transformer parameters. The converter specifications can include, but are not limited to, individual port power, voltages, and currents. For example, the method 3400 can aim to minimize a wide variety of objective functions including, but not limited to, conduction losses, switching losses, core losses, and the volume of the transformer and RCN elements.

The method 3400 can proceed to process block 3406, wherein an iterative procedure can begin with the selection of transformer parameters and RCN parameters such as the number of turns and impedance of RCN circuits. The method 3400 can proceed to process block 3408, where another inner iterative process can initiate. For example, with the selected parameters from process block 3406, duty ratios and phase shifts for the active bridges in various ports of the converter system can be selected. At process block 3408, Fourier coefficients of port voltages and currents can be determined using superposed harmonic analysis and a full-order admittance matrix. At process block 3410, time domain reconstruction of port voltages and currents can be performed, and at process block 3412, an objective function F(x) can be minimized. If no further iteration is desired, the method 3400 can proceed to process block 3414 for post-processing before proceeding to process block 3416 where a pareto curve is generated and an optimal solution is determined. If the determined solution fails to meet predetermined specifications (e.g., physical dimensions and/or efficiency) at decision block 3418, the method 3400 can return to process block 3406 for iteration. Otherwise, the method 3400 can proceed from decision block 3418 to terminal block 3420.

For example, based on the selected parameters, the constrained numerical optimization can minimize the objective function F(x) P_{cond (x)} by selecting the optimal modulation parameters (duty ratio and phase shifts). Furthermore, F(x) can be formulated to include other converter loss mechanisms including transformer core-losses and semiconductor switching losses, in addition to conduction losses in the converter. The constraints can be the reference power and the zero-voltage switching (ZVS condition) of each port. The objective function for minimizing the conduction losses can be expressed as:

minimize F(x)=P_{cond}(x)

x={δ₁,δ₂, . . . δₙ,φ₂,φ₃, . . . Φₙ,f_{sw}}

where, P_{cond}(x)=(Σⱼ₌₁ⁿIⱼ²R_{ac,j}) and j=1, 2, . . . n (number of ports).

The power and ZVS constraints can be expressed as:

Pⱼ(x)=P_{j,ref}; j=1,2, . . . n (number of ports); x={δ₁,δ₂, . . . δₙ,φ₂,φ₃, . . . Φₙ,f_{sw}}

½LⱼIⱼ(a)²>C_{sw}(Vⱼ(a))Vⱼ(a)²; j=1,2, . . . n (number of ports), a=switching instant,

where C_{sw}(V) is the non-linear output capacitance of the switches with respect to the voltage. The optimal modulation parameters and volume of the transformer, which otherwise meet the efficiency and size constraints, can be selected.

In practical embodiments, the multi-port converters may not always operate at their full power rating. Therefore, targeting only a high full-load efficiency could perform poorly in terms of total energy loss. Therefore, a weighted efficiency (η_{w}) can be obtained by computing a weighted sum of efficiencies at different power levels:

η_{w}=w₁η_{20%}+w₂η_{40%}+w₃η_{60%}+w₄η_{80%}+w₅η_{100%}

The weights and corresponding power levels can be determined with the objective of minimizing total energy loss in the converter for a given load profile. In some embodiments, the loading percentages and number of weights can be extended to any number of points depending on the application. In addition, power density (ρ) computation can be parameterized by using component physical dimensions based on their specifications, which can allow another expression to be obtained for the converter volume. The obtained expressions for weighted efficiency (η_{w}) and the converter volume can be used by the optimization algorithm of choice as objective functions to evaluate different combinations of circuit parameters to generate a pareto front for η_{w}−ρ. The final design can be selected from the set of pareto-optimal designs by evaluating the performance in terms of weighted efficiency (η_{w}), power density (ρ), and/or design feasibility.

Although some of blocks 3402-3420 of FIG. 34 have been described as being performed once, in some embodiments, multiple repetitions of a particular process block may be employed before proceeding to the next decision block or process block. In addition, although blocks 3402-3420 have been separately illustrated and described, in some embodiments, process blocks may be combined and performed together (simultaneously or sequentially). Moreover, although FIG. 34 illustrates a particular order for blocks 3402-3420, embodiments of the disclosed subject matter are not limited thereto. Indeed, in certain embodiments, the blocks may occur in a different order than illustrated or simultaneously with other blocks.

### Exemplary Control of Multi-Port Power Converters

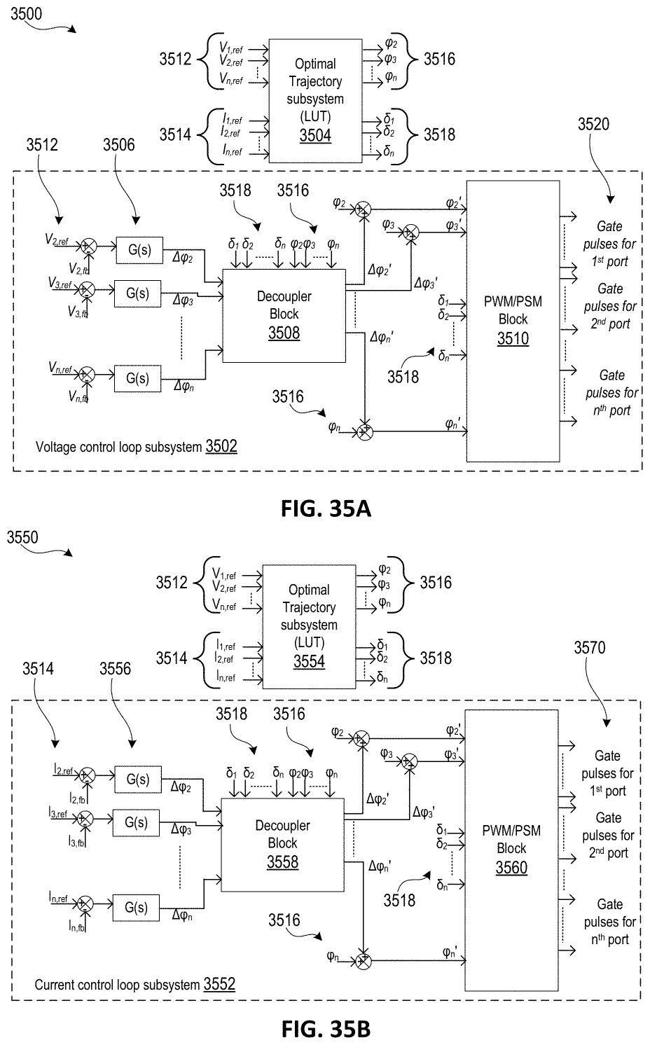

In some embodiments, an n-port converter system can have n number of subsystems, which can be arranged as active full bridges. The voltages at each port V₁, V₂ . . . Vₙ can be maintained at their nominal values by controlling the duty ratios δ₁, δ₂, . . . δₙ of the subsystem output voltage and the phase shift φ₂, φ₃ . . . φₙ₁ between the voltage of the subsystems, where φⱼ indicates the phase difference between the jth and the 1^{st} port. Referring to FIGS. 35A-35B, exemplary closed-loop control schemes for an n-port MAB converter are shown, with FIG. 35A illustrating a scheme 3500 for output voltage control and FIG. 35B illustrating a scheme 3550 for output current control. For example, the output voltage control scheme 3500 of FIG. 35A can be used for constant voltage applications (e.g., energy router, resistive loads, etc.), while the output current control scheme 3550 of FIG. 35B can be used for constant current applications (e.g., battery charging for EVs).

In either configuration, a closed loop control system can comprise a control loop subsystem (e.g., voltage control loop subsystem 3502 or current control loop subsystem 3552) and optimal trajectory subsystem 3554, which can determine the phase angle difference and duty ratios to control the port voltages and currents at its reference value. In the output voltage control scheme 3500, the voltage control loop subsystem 3502 can comprise and/or be defined by a controller block 3506, a decoupler block 3508, and a PWM/PSM block 3510. Similarly, in the output current control scheme 3550, the current control loop subsystem 3552 can comprise and/or be defined by a controller block 3556, a decoupler block 3558, and a PWM/PSM block 3560. Each controller block 3506, 3556 can comprise and/or be defined by a set of proportional and integral control (e.g., G(s)), which takes sampled port voltages 3512 and/or currents 3514 (measured using voltage and current sensors) as feedback and makes the error between the sampled feedback and reference as zero. Each decoupler block 3508, 3558 can be used to compensate for the cross-coupling between the two different ports, such that changes in one port will not affect the other ports.

The optimal trajectory subsystem 3504 or 3554 can generate steady-state duty ratios 3516 and phase shifts 3518 based on the generalized harmonic analysis. The steady-state duty ratios 3516 and phase angle differences 3518 can act as feedforward terms and can be added to the respective control loop subsystem output that is fed to the PWM/PSM block 3510 or 3560. The PWM/PSM block 3510 or 3560 in the control loop subsystem 3502 or 3552 can then be used to generate gate pulses 3520 or 3570 with appropriate deadtimes for the switches in the active bridges of various ports.

The control scheme is generic and can be implemented using any type of computer or processor, such as real-time DSP microcontrollers and/or FPGA controllers. In some embodiments, the power transfer for a port can be interrupted, or a port can be excluded from the system by hardware methods and/or software methods. For example, exemplary hardware methods can be implemented by adding a series back-to-back switch and operating it appropriately. Alternatively or additionally, exemplary software methods can be implemented by making the duty ratio for the respective port to zero (δⱼ=π/2).

Another significant challenge that differentiates multi-port converters from conventional two-port converters is the cross-coupling of the matrix power flow in the multi-winding transformer, wherein the modification of one phase-shift (φ,δ) perturbs the power processed by all other ports. The coupled nonlinear relationship of phase-shifts with port powers can make it important to develop a phase-shift decoupling strategy to enable the use of conventional controllers for power flow regulation. In some embodiments, the designed controller can optimally modulate the inner phase-shifts (δ) and/or the switching frequency (f_{sw}) to minimize the converter losses while ensuring soft-switching.

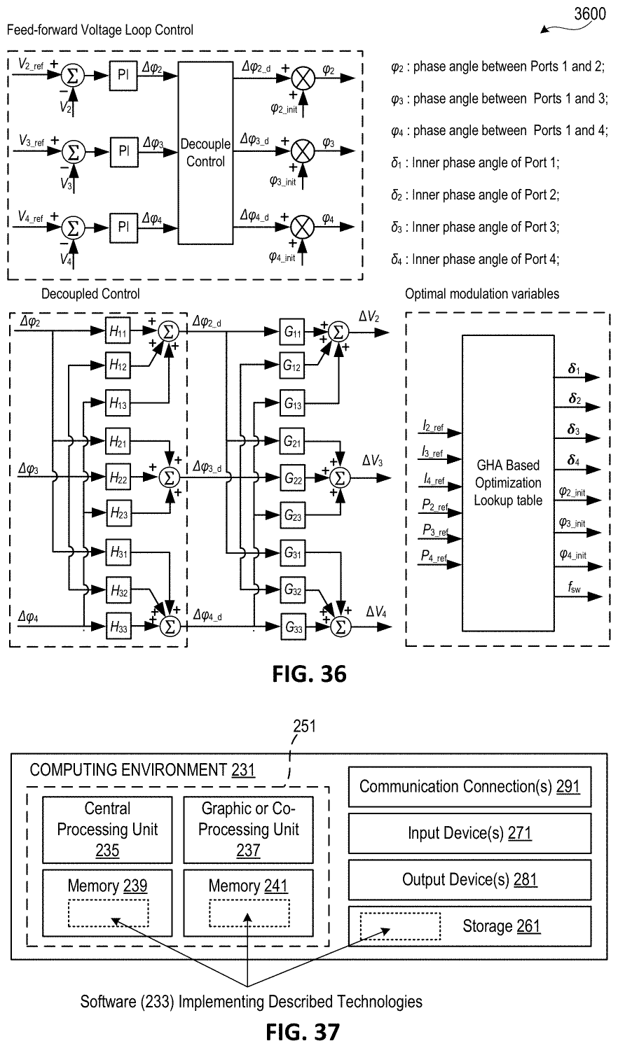

To achieve such goals, in some embodiments, a feed-forward multi-dimensional lookup-table (LUT) based approach can be used. The use of LUTs to store the trajectories of modulation variables can ensure that the converter operates optimally over its entire operating range (or at least a predetermined portion thereof). In some embodiments, the frequency domain generalized harmonic approximation (GHA) based optimal modulation strategy disclosed herein can be used to generate accurate look-up table values offline for all operating conditions. Next, to decouple the power flow with the LUT-based control, a closed loop control method can be used. For example, FIG. 36 exhibits an exemplary configuration 3600 of a hybrid closed-loop and feed-forward approach that enables a closed loop control implementation for a four port MAB converter.

From the small-signal modelling of the resonant QAB converter, the output voltage variations (ΔV2, ΔV3, ΔV4) are the product of the outer phase-shift angle variations (Δφ2, Δφ3, Δφ4) and the converter's transfer matrix G, expressed by below where £ is the scaling coefficient.

$$[ \begin{matrix}Δ {V}_{2} \\ Δ {V}_{3} \\ Δ {V}_{4}\end{matrix} ] = [ \begin{matrix}{G}_{11} & {G}_{12} & {G}_{13} \\ {G}_{21} & {G}_{22} & {G}_{23} \\ {G}_{31} & {G}_{32} & {G}_{33}\end{matrix} ] * [ \begin{matrix}{Δφ}_{2} \\ {Δφ}_{3} \\ {Δφ}_{4}\end{matrix} ] = 𝔏 G * [ \begin{matrix}{Δφ}_{2} \\ {Δφ}_{3} \\ {Δφ}_{4}\end{matrix} ]$$

There are cross-coupling characteristics between the output voltage and the outer phase-shift angle variations. One approach to eliminate the cross-coupling effects and realize independent output voltage control for each individual port is to introduce a decoupling matrix H as given by:

$$[ \begin{matrix}Δ {V}_{2} \\ Δ {V}_{3} \\ Δ {V}_{4}\end{matrix} ] = [ \begin{matrix}{G}_{11} & {G}_{12} & {G}_{13} \\ {G}_{21} & {G}_{22} & {G}_{23} \\ {G}_{31} & {G}_{32} & {G}_{33}\end{matrix} ] * [ \begin{matrix}{H}_{11} & {H}_{12} & {H}_{13} \\ {H}_{21} & {H}_{22} & {H}_{23} \\ {H}_{31} & {H}_{32} & {H}_{33}\end{matrix} ] * [ \begin{matrix}{Δφ}_{2} \\ {Δφ}_{3} \\ {Δφ}_{4}\end{matrix} ] = G * H * [ \begin{matrix}{Δφ}_{2} \\ {Δφ}_{3} \\ {Δφ}_{4}\end{matrix} ]$$

When H=G⁻¹, the output voltage variations and the outer phase-shift angle variations meet for a linear matrix equation, which indicates they are successfully decoupled. The precision of G affects the decoupling performance of the power flow control. Existing methods compute matrix G based on the Fundamental Harmonic Approximation (FHA) of port voltages. While these methods may offer good decoupling performance when the port high-frequency voltages and currents are close to sinusoidal, such as at the resonant operating point, such FHA-based methods cannot guarantee high accuracy at other operating points since the high-order harmonic components are non-negligible. In some embodiments, to address this issue, the converter's transfer matrix G can be derived using GHA based on the Taylor series of the port voltages. Since higher-order harmonic components besides the fundamental component are considered, the modeling accuracy can improve prediction of converter dynamic characteristics and estimation of stability margins. The proposed decoupled power flow control method together with the hybrid PI and feed-forward control can more tightly regulate the output voltage during all relevant load transients.

### Computer Implementation

FIG. 37 depicts a generalized example of a suitable computing environment 231 in which the described innovations may be implemented, such as aspects of controller 122, method 3400, methods of MAB power converter design and/or optimization, methods for modeling MAB power converters, and methods for operation and/or control of MAB power converters. The computing environment 231 is not intended to suggest any limitation as to scope of use or functionality, as the innovations may be implemented in diverse general-purpose or special-purpose computing systems. For example, the computing environment 231 can be any of a variety of computing devices (e.g., desktop computer, laptop computer, server computer, tablet computer, etc.).

The computing environment 231 includes one or more processing units 235, 237 and memory 239, 241. In FIG. 37, this basic configuration 251 is included within a dashed line. The processing units 235, 237 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 2 shows a central processing unit 235 as well as a graphics processing unit or co-processing unit 237. The tangible memory 239, 241 may be volatile memory (e.g., registers, cache, RAM), non-volatile memory (e.g., ROM, EEPROM, flash memory, etc.), or some combination of the two, accessible by the processing unit(s). The memory 239, 241 stores software 233 implementing one or more innovations described herein, in the form of computer-executable instructions suitable for execution by the processing unit(s).

A computing system may have additional features. For example, the computing environment 231 includes storage 261, one or more input devices 271, one or more output devices 281, and one or more communication connections 291. An interconnection mechanism (not shown) such as a bus, controller, or network interconnects the components of the computing environment 231. Typically, operating system software (not shown) provides an operating environment for other software executing in the computing environment 231, and coordinates activities of the components of the computing environment 231.

The tangible storage 261 may be removable or non-removable, and includes magnetic disks, magnetic tapes or cassettes, CD-ROMs, DVDs, or any other medium which can be used to store information in a non-transitory way, and which can be accessed within the computing environment 231. The storage 261 can store instructions for the software 233 implementing one or more innovations described herein.

The input device(s) 271 may be a touch input device such as a keyboard, mouse, pen, or trackball, a voice input device, a scanning device, or another device that provides input to the computing environment 231. The output device(s) 271 may be a display, printer, speaker, CD-writer, or another device that provides output from computing environment 231.

The communication connection(s) 291 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart-phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A power conversion system comprising multiple ports coupled together via a transformer, the system employing an electrically- and magnetically-integrated isolated multi-port power conversion architecture for any of AC-to-DC, DC-to-DC, DC-to-AC, and AC-to-AC conversion and supporting multi-directional power flow.
Clause 2. The power conversion system of any clause or example herein, in particular, Clause 1, wherein the multiple ports comprise at least three ports with different voltage levels (e.g., four or more ports), each port being one of single-phase AC, three-phase AC, or DC, the multiple ports being connected in series, parallel, or stacked configurations.
Clause 3. The power conversion system of any clause or example herein, in particular, any one of Clauses 1-2, wherein the multi-directional power flow is such that an arbitrary number of ports act as sources to the system while remaining ports act as sinks to the system.
Clause 4. The power conversion system of any clause or example herein, in particular, any one of Clauses 1-3, wherein one or some of the ports act as an active pulsating power buffer (PPB) (e.g., acting as neither a power source nor a power sink).
Clause 5. The power conversion system of any clause or example herein, in particular, any one of Clauses 1-4, wherein at least one first port interfaces a single-phase or three-phase AC voltage, and the first port comprises a single-stage or two-stage topology.
Clause 6. The power conversion system of any clause or example herein, in particular, any one of Clauses 1-5, wherein the transformer is a high-frequency transformer, and each port is connected to the high-frequency transformer through a resonant coupling network (RCN).
Clause 7. The power conversion system of any clause or example herein, in particular, any one of Clauses 1-6, wherein a high-frequency circuit topology of each port is configured as a full-bridge, a half-bridge, a multilevel bridge, a three-phase bridge, bridges connected in a matrix configuration, or any combination of the foregoing.
Clause 8. The power conversion system of any clause or example herein, in particular, any one of Clauses 1-7, wherein the transformer is a multi-winding high-frequency isolation transformer, and the transformer has a single-phase, three-phase, or matrix-based configuration.
Clause 9. The power conversion system of any clause or example herein, in particular, any one of Clauses 1-8, wherein each port comprises a resonant or non-resonant coupling network, and the system comprises a symmetric or asymmetric arrangement of coupling networks on the ports.
Clause 10. The power conversion system of any clause or example herein, in particular, any one of Clauses 1-9, wherein the architecture employs a modular arrangement of multi-port converters or components thereof connected in series, in parallel, or in a stacked configuration.
Clause 11. A method for operation of the power conversion system of any clause or example herein, in particular, any one of Clauses 1-10, comprising closed-loop, multi-phase-shift, multi-duty ratio, variable switching frequency operation.
Clause 12. The method of any clause or example herein, in particular, Clause 11, wherein the power conversion system comprises a DC-to-DC multi-port resonant converter with at least three ports (e.g., each port having a configuration as listed in Table 1), and one or more modulation degrees of freedom are fixed in a trade-off between optimal performance and computation complexity.
Clause 13. The method of any clause or example herein, in particular, any one of Clauses 11-12, wherein for a half-bridge port without a DC-blocking capacitor, the phase-shift of the switching leg is independently varied, and the switching frequency of all switches is varied in conjunction with all other switches in the converter.
Clause 14. The method of any clause or example herein, in particular, any one of Clauses 11-13, wherein for a half-bridge port without a DC-blocking capacitor, the phase-shift and duty ratio of the switching leg are independently varied, and the switching frequency of all switches is varied in conjunction with all other switches in the converter.
Clause 15. The method of any clause or example herein, in particular, any one of Clauses 11-14, wherein for a full-bridge port, the phase shifts of both legs and duty ratios of both legs are independently varied, and the switching frequency of all switches is varied in conjunction with all other switches in the converter.
Clause 16. The method of any clause or example herein, in particular, any one of Clauses 11-15, wherein for a multi-level bridge, and active neutral point clamped (ANPC) or flying capacitor (FC) is employed, all of the phase shifts between the legs and duty ratios of both legs are independently varied, and the switching frequency of all switches is varied in conjunction with all other switches in the converter.
Clause 17. The method of any clause or example herein, in particular, any one of Clauses 11-16, wherein for bridge connections with matrix transformer configuration, the multiple bridges are effectively connected in parallel on a given port, and a set of phase shifts, duty ratios, and frequency for parallel bridges on the same port is kept identical except for the variations of Clauses 12-16.
Clause 18. The method of any clause or example herein, in particular, any one of Clauses 11-17, wherein one or more of the ports comprises a single-phase AC port without intermediate energy storage (e.g., single-stage operation), and one or some of the switches are commutated at an AC line frequency (e.g., ˜60 Hz) or at multiples of an AC line frequency.
Clause 19. The method of any clause or example herein, in particular, any one of Clauses 11-18, wherein one or more of the ports comprises a three-phase AC port without intermediate energy storage (e.g., single-stage operation), and one or some of the switches are commutated at an AC line frequency (e.g., ˜60 Hz) or at multiples of an AC line frequency.
Clause 20. The method of any clause or example herein, in particular, any one of Clauses 11-19, wherein one or more of the ports comprises a power pulsation buffer (PPB) operated a switching frequency that is the same as the rest of the multi-port converter, such that the PPB stores intermediate energy over an AC line cycle but does not supply or sink any average power.
Clause 21. A method for modeling operation of the power conversion system of any clause or example herein, in particular, any one of Clauses 1-10, comprising a frequency-domain modeling approach including generalized modeling of “m−1” phase shifts, “m” duty ratios, and switching frequency for a multi-port converter that has “m” independent two-level bridge legs or an equivalent combination of two-level and multi-level bridge legs.
Clause 22. The method of any clause or example herein, in particular, any one of Clauses 11-21, wherein the modeling approach comprises a generalized matrix-based modeling approach that includes translation of phase shifts, duty ratios, and switching frequency selection to an “n×n” matrix for an n-port converter, and allows for any arbitrary resonant coupling network and turns ratios for each port connected to the high-frequency transformer.
Clause 23. The method of any clause or example herein, in particular, any one of Clause 11-22, wherein the modeling approach is applicable to a DC-to-DC operating point comprising fixed DC voltages and powers on each port, and/or is applicable to single-stage AC-to-DC or DC-to-AC multi-port converters by discretization of the AC line cycle into a finite number of DC-to-DC operating points so as to preserve sufficient accuracy.
Clause 24. A method for design optimization of the power conversion system of any clause or example herein, in particular, any one of Clauses 1-10, comprising using the modulation and/or modeling frameworks of any of Clauses 11-23.
Clause 25. The method of any clause or example herein, in particular, Clause 24, wherein one or more loss objectives for a multiport converter are modeled and optimized by finding one or more corresponding optimal design parameters.
Clause 26. The method of any clause or example herein, in particular, Clause 25, wherein the one or more loss objectives comprises conduction losses, core losses, switching losses, or any combination of the foregoing, and/or the one or more optimal design parameters comprises turns ratios, resonant coupling network structure, resonant coupling network values, or any combination of the foregoing.
Clause 27. The method of any clause or example herein, in particular, any one of Clauses 24-26, further comprising constraints on achieving soft switching at all relevant operating points.
Clause 28. The method of any clause or example herein, in particular, any one of Clauses 24-27, wherein optimization objective functions are weighted by different operating points of the multi-port converters (e.g., combinations of different voltage and/or power levels at each port).
Clause 29. A method for control of the power conversion system of any clause or example herein, in particular, any one of Clauses 1-10, comprising a closed-loop optimal control scheme that enables multi-directional power flow with any number of input ports and any number of output ports.
Clause 30. The method of any clause or example herein, in particular, Clause 29, wherein the control scheme employs a hybrid approach comprising predetermined (e.g., computed offline) feedforward parameters for optimal operation and closed-loop feedback controllers for tracking and disturbance rejection due to parameter changes or other operating factors.
Clause 31. The method of any clause or example herein, in particular, any one of Clauses 29-30, wherein the control scheme comprises independent control of voltages and currents at each port (thus regulation power flow), tracking of an optimal root-mean-squared (RMS) currents, and maximizing ZVS/ZCS for all MOSFET devices over an entire load range.
Clause 32. The method of any clause or example herein, in particular, any one of Clauses 29-31, comprising a power decoupling approach, wherein the power flows among various ports are decoupled so as to realize superior transient performance and wherein the load or voltage changes on one port are decoupled from other ports.
Clause 33. The method of any clause or example herein, in particular, any one of Clauses 29-32, wherein the method is configured to be performed by firmware without any added hardware so as to realize zero power flow on any port.
Clause 34. The method of any clause or example herein, in particular, any one of Clauses 29-33, wherein the feedback controller operates in a voltage-mode control regime or average current-mode control regime.
Clause 35. The method of any clause or example herein, in particular, any one of Clauses 11-34, wherein the method is configured to be performed by a processor or microcontroller, with stored lookup tables (e.g., offline computation) for optimal operation along with closed-loop feedback controllers.

### CONCLUSION

Any of the features illustrated or described herein, for example, with respect to FIGS. 1-37 and Clauses 1-35, can be combined with any other feature illustrated or described herein, for example, with respect to FIGS. 1-37 and Clauses 1-35 to provide systems, devices, methods, and embodiments not otherwise illustrated or specifically described herein. Indeed, all features described herein are independent of one another and, except where structurally impossible, can be used in combination with any other feature described herein.

In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A multi-port power conversion system comprising:
a multi-winding transformer; and
at least three ports coupled to the multi-winding transformer, each port having a semiconductor bridge and a coupling network,
wherein for each port:
the semiconductor bridge has two or more levels and comprises at least two switches,
the coupling network comprises at least one inductor, and
the semiconductor bridge is coupled to the multi-winding transformer via the respective coupling network.

2. The multi-port power conversion system of claim 1, wherein the at least three ports is four or more ports coupled to the same multi-winding transformer.

3. The multi-port power conversion system of claim 1, wherein one of the at least three ports is an AC port, and another of the at least three ports is a DC port.

4. The multi-port power conversion system of claim 3, further comprising a line frequency synchronous rectifier coupled to the semiconductor bridge for the AC port, so as to form a single stage subsystem for the AC port.

5. The multi-port power conversion system of claim 4, wherein the line frequency synchronous rectifier comprises a full bridge configuration having four semiconductor switches.

6. The multi-port power conversion system of claim 4, wherein the line frequency synchronous rectifier is configured as a three-phase line frequency synchronous rectifier and comprises a three-phase bridge having at least six semiconductor switches.

7. The multi-port power conversion system of claim 3, wherein the semiconductor bridge for the AC port has a single-stage three-phase configuration comprising two or more levels.

8. The multi-port power conversion system of claim 7, wherein the single-stage three-phase configuration comprises at least twelve semiconductor switches.

9. The multi-port power conversion system of claim 3, further comprising a power factor correction (PFC) rectifier coupled to the semiconductor bridge for the AC port, so as to form a two-stage subsystem for the AC port.

10. The multi-port power conversion system of claim 9, wherein the PFC rectifier comprises at least one boost inductor and a full bridge configuration having four semiconductor switches.

11. The multi-port power conversion system of claim 9, wherein the PFC rectifier is configured as a three-phase PFC rectifier and comprises at least six semiconductor switches and at least three boost inductors.

12. The multi-port power conversion system of claim 1, wherein one of the at least three ports is configured as a power pulsation buffer port.

13. The multi-port power conversion system of claim 1, wherein each semiconductor bridge has a configuration selected from a group consisting of full-bridge, half-bridge with split capacitors, half-bridge with DC-blocking capacitor, multi-level active neutral point clamped (ANPC) full-bridge, multi-level ANPC half-bridge, multi-level neutral point clamped (NPC) full-bridge, multi-level NPC half-bridge, multi-level flying-capacitor (FC) full-bridge, multi-level FC half-bridge, multi-level T-type full-bridge, multi-level T-type half-bridge, three-phase bridge, three-phase multi-level ANPC bridge, three-phase multi-level FC bridge, and parallel or matrix variations of any of the foregoing.

14. The multi-port power conversion system of claim 1, wherein the multi-winding transformer has a configuration selected from a group consisting of single-phase transformer, three-phase or n-phase transformer, single-phase matrix transformer, single-phase matrix transformer with inversely coupled windings, three-phase or n-phase matrix transformer, and three-phase or n-phase zig-zag transformer.

15. The multi-port power conversion system of claim 1, wherein each coupling network has a configuration selected from a group consisting of LC series resonant, CLL resonant, CLLLC resonant, parallel LC resonant, LCCLL resonant, LCCL resonant, LCL resonant, and non-resonant L.

16. The multi-port power conversion system of claim 1, wherein one, some, or all of the coupling networks are configured as resonant coupling networks (RCNs) formed by at least one capacitor and one inductor.

17. The multi-port power conversion system of claim 16, wherein:
a configuration of each coupling network is the same, so as to form a symmetric resonant network topology; or
the configuration of one of the coupling networks is different from that of another of the coupling networks, so as to form an asymmetric resonant network topology.

18. The multi-port power conversion system of claim 1, further comprising a controller operatively coupled to the semiconductor bridges, the controller comprising at least one processor and computer readable storage media storing instructions that, when executed by the at least one processor, cause the controller to control (i) switching frequency, (ii) phase shift, (iii) duty ratio, or any combination of (i)-(iii) of one or more switches of the semiconductor bridges.

19. The multi-port power conversion system of claim 18, wherein the controller is configured to perform phase-shift modulation, pulse-frequency modulation, phase-width modulation, or any combination of the foregoing in controlling the one or more switches of the semiconductor bridges.

20. The multi-port power conversion system of claim 18, comprising:
a look-up table storing predetermined feed-forward values for phase shifts, switching frequency, or both based on input values of (a) voltage, (b) current, (c) power, or any combination of (a)-(c),
wherein the computer readable storage media stores instructions that, when executed by the at least one processor, further cause the controller to control the one or more switches of the semiconductor bridges based on the predetermined feed-forward values and by employing closed-loop control scheme.
